(19) United States
(12) Patent Application Publication
(10) Pub. No.: US 2013/0212298 A1
(43) Pub. Date: Aug. 15, 2013

(54) SIP MESSAGE PROCESSING

(71) Applicant: Metaswitch Networks Ltd., (US)

(72) Inventors: Jim Bunch, Dallas, TX (US); Jose Deras, Southlake, TX (US); Gerry Dubois, Dallas, TX (US); Naga Pokala, Southlake, TX (US); Phil Francis, Plano, TX (US); Craig Miller, Dallas, TX (US)

(73) Assignee: METASWITCH NETWORKS LTD., Enfield (GB)

(21) Appl. No.: 13/713,731

(22) Filed: Dec. 13, 2012

Related U.S. Application Data
(60) Provisional application No. 61/570,425, filed on Dec. 14, 2011.

(51) Int. Cl. H04L 12/56

(52) U.S. Cl. CPC H04L 45/42; H04L 65/1006
USPC 709/244

(57) ABSTRACT

A method of processing Session Initiation Protocol (SIP) signalling messages in a telecommunications network is provided. The method includes, at a SIP routing element, maintaining a routing database containing routing data for routing SIP signalling messages between SIP network elements, maintaining a group of simultaneously active modes including at least a SIP proxy server stateless mode and a SIP proxy server stateful mode, receiving a plurality of SIP signalling messages from SIP network elements, routing at least some of the received SIP signalling messages with reference to the routing database according to a SIP proxy server stateless mode, and routing at least some of the received messages with reference to the routing database according to a SIP proxy server stateful mode.

### CROSS-REFERENCE TO RELATED APPLICATIONS

This application is a Nonprovisional of U.S. Provisional Patent Application Ser. No. 61/570,425, filed on Dec. 14, 2011, the disclosure of which is incorporated herein by reference in its entirety.

### TECHNICAL FIELD

The present invention relates to routing. In particular, but not exclusively, the present invention relates to methods, apparatus and computer program products for processing Session Initiation Protocol (SIP) signalling messages in a telecommunications network.

### BACKGROUND

Service providers are now accelerating the move to next generation networks including steps towards a full IP Multimedia Subsystem (IMS) architecture. For next generation networks including IMS the fundamental core network signalling technology is based on SIP. The transition to SIP signalling provides advantages over current core network signalling technologies but also creates new networking problems for the service providers.

Today, the fundamental core network signalling technology is primarily based on Signalling System No. 7 (SS7). In the 1980s and 1990s, service providers deployed large scale SS7 networks based on industry standards utilizing Signal Transfer Points (STP), Signalling Points (SP), and Service Switching Points (SSP) network equipment to route, switch, and manage the core network signalling traffic. Today, service providers are faced with many of the same core network signalling problems that the SS7 network solved in the past except the signalling technology is transitioning to SIP.

However, the SIP industry standards do not address many of the routing, switching, and management issues that service providers encounter when deploying SIP signalling networks.

Some major issues encountered by service providers when deploying SIP signalling networks include the following:
Incompatible versions of SIP deployed by interconnected network elements caused by incomplete or proprietary implementations of SIP;
Variances in use of SIP headers between IMS and NGN networks;
Understanding when to deploy stateless proxy, stateful proxy, or back-to-back user agents;
Flexibility to deploy distributed or centralized routing databases;
SIP network management and troubleshooting;
Aiding traffic studies and network evolution planning;
Readiness for projected SIP signalling traffic capacity growth;
Support for deployment of other SIP based network functionalities;
Integration challenges with legacy switching and application protocols.

It would therefore be desirable to provide a comprehensive set of network functionalities to tackle at least the issues outlined above.

### SUMMARY

In accordance with embodiments, there is a method of processing Session Initiation Protocol (SIP) signalling messages in a telecommunications network, the network comprising a SIP routing element and a plurality of SIP network elements, each of the SIP network elements in the plurality being configured to forward SIP signalling messages to the SIP routing element for routing across the network, the method comprising, at the SIP routing element:
maintaining a routing database containing routing data for routing SIP signalling messages between SIP network elements in the plurality;
maintaining a group of simultaneously active modes including at least a SIP proxy server stateless mode and a SIP proxy server stateful mode;
receiving a plurality of SIP signalling messages from SIP network elements in the plurality of SIP network elements;
routing at least some of the received SIP signalling messages with reference to the routing database according to a SIP proxy server stateless mode; and
routing at least some of the received messages with reference to the routing database according to a SIP proxy server stateful mode.

In accordance with embodiments, there is apparatus for use in processing Session Initiation Protocol (SIP) signalling messages in a telecommunications network, the network comprising a SIP routing element and a plurality of SIP network elements, each of the SIP network elements in the plurality being configured to forward SIP signalling messages to the SIP routing element for routing across the network, the apparatus being adapted to, at the SIP routing element:
maintain a routing database containing routing data for routing SIP signalling messages between SIP network elements in the plurality;
maintain a group of simultaneously active modes including at least a SIP proxy server stateless mode and a SIP proxy server stateful mode;
receive a plurality of SIP signalling messages from SIP network elements in the plurality of SIP network elements;
route at least some of the received SIP signalling messages with reference to the routing database according to a SIP proxy server stateless mode; and route at least some of the received messages with reference to the routing database according to a SIP proxy server stateful mode.

In accordance with embodiments, there is a computer program product comprising a non-transitory computer-readable storage medium having computer readable instructions stored thereon, the computer readable instructions being executable by a computerized device to cause the computerized device to perform a method for processing Session Initiation Protocol (SIP) signalling messages in a telecommunications network, the network comprising a SIP routing element and a plurality of SIP network elements, each of the SIP network elements in the plurality being configured to forward SIP signalling messages to the SIP routing element for routing across the network, the method comprising, at the SIP routing element:
maintain a routing database containing routing data for routing SIP signalling messages between SIP network elements in the plurality;
maintain a group of simultaneously active modes including at least a SIP proxy server stateless mode and a SIP proxy server stateful mode;
receive a plurality of SIP signalling messages from SIP network elements in the plurality of SIP network elements;
route at least some of the received SIP signalling messages with reference to the routing database according to a SIP proxy server stateless mode; and route at least some of the received messages with reference to the routing database according to a SIP proxy server stateful mode.

In accordance with embodiments, there is a method of processing Session Initiation Protocol (SIP) signalling messages in a telecommunications network comprising a plurality of SIP network elements, the method comprising, at a SIP network element:
maintaining a database containing preferred data transport types of one or more remote SIP network elements;
receiving a plurality of SIP signalling messages from one or more remote SIP network elements; and
routing at least some of the received plurality of SIP signalling messages with reference to the database.

In accordance with embodiments, there is a method of processing Session Initiation Protocol (SIP) signalling messages in a telecommunications network comprising a plurality of SIP network elements, the method comprising, at a SIP network element:
maintaining a database containing both SIP Uniform Resource Identifiers (URIs) associated with Internet Protocol version 4 (IPv4) network addresses and different SIP URIs associated with Internet Protocol version 6 (IPv6) network addresses of one or more remote SIP network elements;
receiving a plurality of SIP signalling messages from one or more remote SIP network elements;
routing at least some of the received plurality of SIP signalling messages with reference to the database.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows a system diagram according to the prior art.

FIG. 2 shows a system diagram according to embodiments.

FIG. 3 shows a flow diagram according to embodiments.

FIG. 4 shows a block diagram according to embodiments.

FIG. 5 shows a block diagram according to embodiments.

FIG. 6 shows a block diagram according to embodiments.

FIG. 7 shows a block diagram according to embodiments.

FIG. 8 shows a block diagram according to embodiments.

FIG. 9 shows a block diagram according to embodiments.

FIG. 10 shows a block diagram according to embodiments.

FIG. 11 shows a system diagram according to embodiments.

FIG. 12 shows a flow diagram according to embodiments.

FIG. 13 shows a block diagram according to embodiments.

FIG. 14 shows a block diagram according to embodiments.

FIG. 15 shows a system diagram according to embodiments.

FIG. 16 shows a system diagram according to embodiments.

FIG. 17 shows a system diagram according to embodiments.

FIG. 18 shows a system diagram according to the prior art.

FIG. 19 shows a system diagram according to embodiments.

FIG. 20 shows a flow diagram according to embodiments.

FIG. 21 shows a flow diagram according to embodiments.

FIG. 22 shows a flow diagram according to embodiments.

### DETAILED DESCRIPTION

Embodiments relate to processing Session Initiation Protocol (SIP) signalling messages in a telecommunications network. The network comprises a SIP routing element and a plurality of SIP network elements. Each of the SIP network elements in the plurality is configured to forward SIP signalling messages to the SIP routing element for routing across the network.

The SIP routing element maintains a routing database containing routing data for routing SIP signalling messages between SIP network elements in the plurality.

The SIP routing element also maintains a group of simultaneously active modes including at least a SIP proxy server stateless mode and a SIP proxy server stateful mode.

The SIP routing element is configured to receive a plurality of SIP signalling messages from SIP network elements in the plurality.

The SIP routing element routes at least some of the received SIP signalling messages with reference to the routing database according to a SIP proxy server stateless mode and the SIP routing element routes at least some of the received messages with reference to the routing database according to a SIP proxy server stateful mode.

In embodiments, the SIP routing element maintains a group of simultaneously active modes including at least a SIP proxy server stateless mode, a SIP proxy server transaction stateful mode and a SIP proxy server call stateful mode.

In such embodiments, the SIP routing element routes at least some of the received SIP signalling messages with reference to the routing database according to a SIP proxy server stateless mode, routes at least some of the received SIP signalling messages with reference to the routing database according to a SIP proxy server transaction stateful mode, and routes at least some of the received SIP signalling messages with reference to the routing database according to a SIP proxy server call stateful mode.

In embodiments, the SIP routing element processes at least some of the received SIP signalling messages according to a SIP back-to-back user agent mode. In addition to being capable of operating in a SIP back-to-back user agent mode for some received messages, the SSR is also capable of operating in one or more SIP proxy server modes for other received messages. The SIP proxy server modes may include a SIP proxy server stateless mode, a SIP proxy server transaction stateful mode and a SIP proxy server call stateful mode.

In embodiments, the SIP routing element provides service broker functionality in relation to at least some of the received SIP signalling messages.

In embodiments, the SIP routing element provides media resource broker functionality in relation to at least some of the received SIP signalling messages.

In embodiments, the SIP routing element provides session centralisation and continuity application server functionality in relation to at least some of the received SIP signalling messages.

In embodiments, the SIP routing element provides load balancing functionality in relation to one or more application server SIP network elements and/or one or more media server SIP network elements.

In embodiments, the network comprises a further SIP routing element operating as a mated pair in relation to the SIP routing element, the two SIP routing elements being located remotely from each other. The routing database of one SIP routing element in the mated pair is synchronised with the routing database of the other SIP routing element in the mated pair.

In embodiments, the SIP routing element routes at least some of the received SIP signalling messages with reference to an external routing database.

In embodiments, the SIP routing element carries out SIP protocol message normalisation in relation to at least some of the received SIP signalling messages.

In embodiments, the SIP routing element discards one or more of the received SIP signalling messages during message overload conditions.

In embodiments, the SIP routing element generates, at least on the basis of the received SIP signalling messages, one or more SIP signalling message traffic metrics and/or one or more event based session detail records.

In embodiments, the SIP routing element monitors the availability of one or more SIP network elements in the plurality.

In embodiments, the SIP routing element provides service assurance functionality.

In embodiments, the SIP routing element provides route advance functionality in relation to the routing of at least some of the received SIP signalling messages according to a SIP proxy server transaction stateful mode and/or the routing of at least some of the received messages according to a SIP proxy server call stateful mode.

In embodiments, the SIP routing element routes at least some of the received SIP signalling messages on the basis of one or more of the following data contained in the respective received message:
a telephone dialing number,
a SIP Uniform Resource Identifiers (URI) or other SIP header, and
a portion of a SIP URI or other SIP header.

The global deployment of Next Generation Networks (NGNs) is accelerating as service providers take advantage of VoIP/SIP inherent benefits of lower costs, improved capabilities and greatly expanded possibilities for new services and features. This growth is seen in both subscriber access as part of the move of the Public Switch Telephone Network (PSTN) to NGN, as well as in the enterprise arena as private branch exchanges (PBXs) being swapped for IP-based PBXs. As the number of SIP-based switches, proxy servers, feature servers, etc. grows, service providers are finding that there are some very significant limitations on how SIP message routing is implemented. Namely, unlike IP data networks that rely on dedicated routing protocols, SIP elements on NGN must be individually provisioned to contain routing tables describing how to reach peers and beyond. Effectively this means that additions/deletions in the NGN affect each and every SIP element, and each one of these elements must be re-provisioned when there is a topology change. This places a great deal of stress on support and deployment teams and limits when maintenance can take place. Of course this also translates into higher operational costs.

SS7 networks inherently have similar limitations but those are addressed by creating hierarchical architectures with Class 5 switches, Class 4 switches, and STPs. However, in NGNs, no such hierarchical architectures exist and therefore NGNs are effectively mesh networks.

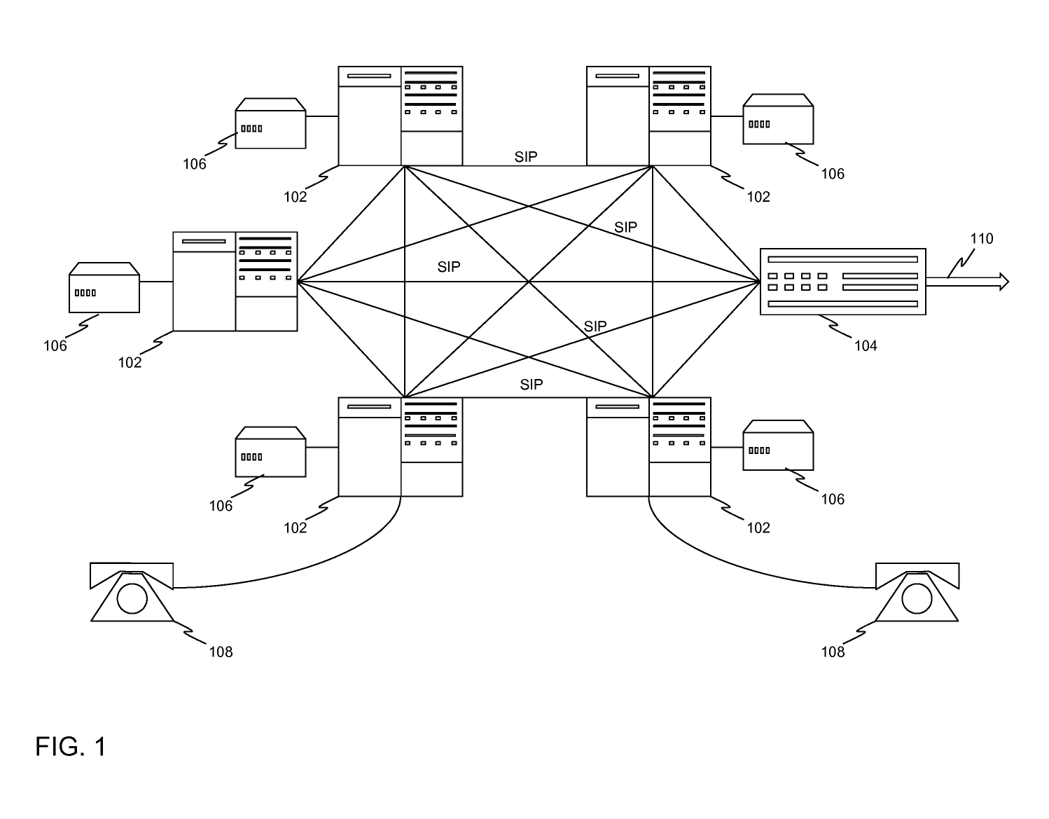

FIG. 1 shows a system diagram of a next generation network (NGN) according to the prior art. FIG. 1 shows a number of SIP network elements, including softswitches 102, application servers 106 and session border gateway (or session border controller, SBC) 104. Each softswitch 102 is connected to a respective application server 106. Endpoint devices 108 such as SIP or Voice over Internet Protocol (VoIP) telephones are connected to respective softswitches 102. Session border gateway 104 is connected 110 to one or more other networks (not shown). Softswitches 102 and session border gateway 104 are all interconnected so the network is effectively a mesh network.

A softswitch provides the architecture for enabling conversion between both media data and signalling protocols via one or more media gateways and signalling gateways, and may also provide call processing intelligence for use in the selection of processes that can be applied to a telephone call, routing for a call within a network based on signalling and subscriber database information, the ability to transfer control of a call to another network element and management functions such as provisioning, fault detection and billing.

A session border gateway is deployed at the border of a network, for example a VoIP network, and protects the network by policing communication sessions such as voice calls (or ‘VoIP calls’) flowing into or out of that network. A session border gateway may have to relay media data for a communication session, for example either because the media data transits the protected network and needs policing, or because the originating and terminating endpoint devices for the communication session cannot send media data to each other directly as they are located in different private networks.

Embodiments tackle problems associated with mesh networks by introducing the concept of hierarchical networks to NGN by introducing a SIP network element in the form of a SIP routing element. The SIP routing element is referred to hereinafter as a SIP Session Router (SSR).

A SIP network element may for example comprise a communication session switching and/or control element such as a softswitch or call agent, a gateway element such as a session border gateway or SBC or media gateway (MGW), an application server, a media server or a PBX.

The SSR is employed to host the routing tables and make the routing decisions that were previously delegated and distributed throughout SIP network elements such as softswitches of the NGN mesh network. The SSR may be viewed as a specialised SIP proxy with the capacity to process the call (or ‘session’) load of the NGN switches, and potentially, with additional capabilities designed to optimize the NGN.

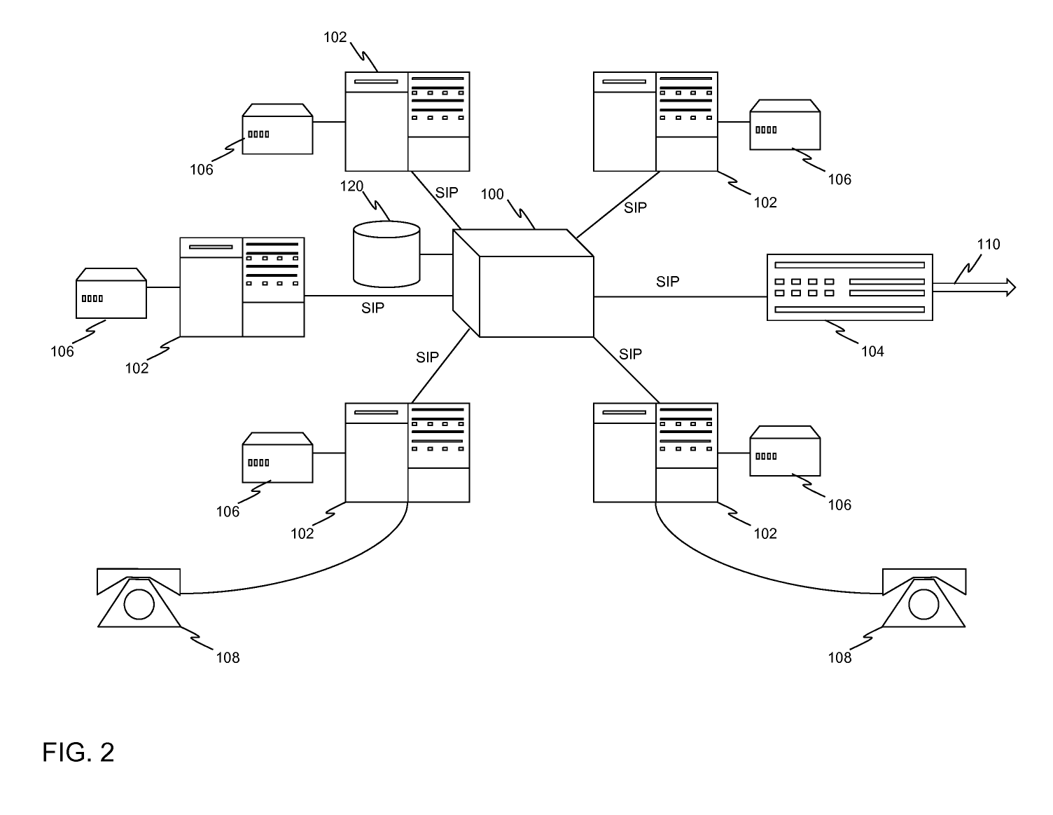

When the SSR is introduced into the NGN, the existing soft switches are re-provisioned with a new upstream peer, the SSR. The system diagram of FIG. 2 depicts deployment of an SSR 100.

FIG. 2 shows a number of SIP network elements, including softswitches 102, application servers 106 and session border gateway 104. In this embodiment, each softswitch 102 is connected to a respective application server 106, but this need not necessarily be the case and can vary in other embodiments. Endpoint devices 108 such as SIP or VoIP telephones are connected to respective softswitches 102. Session border gateway 104 is connected 110 to one or more other networks (not shown). There are no direct connections between softswitches 102 and session border gateway 104; instead, softswitches 102 and session border gateway 104 are all connected to SSR 100 which is added by the service provider between the different logical networks.

SSR 100 has access to a routing database 120 containing routing data for routing SIP signalling messages between SIP network elements such as softswitches 102 and session border gateway 104.

Each of the softswitches 102 and session border gateway 104 are configured to forward SIP signalling messages to SSR 100 for routing across the network.

The network depicted in FIG. 2 is much more manageable than the network depicted in FIG. 1. Additions or deletions to the topology have minimal impact to the rest of the SIP network elements. In some cases, softswitches 102 may gain call processing capacity in that less Central Processing Unit (CPU) cycles are spent making routing and forwarding decisions. In deployments where session border gateways provide access to the service provider network, the provider may actually have many SBCs that connect to it from large enterprises and smaller rural providers. SBCs face the same challenges and also benefit from the introduction of an SSR as a centralized routing point.

SSR 100 is able to provide a number of solutions on the NGN network, all based on the fact that as a central SIP routing platform, a great deal of SIP traffic is inherently visible to it. Whilst an important function of SSR 100 is to centralise SIP routing functions, embodiments described below relate to further functionality of SSR 100.

### Enhanced Proxy Server

The SSR supports basic proxy server capabilities that have been enhanced to address requirements not covered by the SIP standards. The enhanced features are described in the following subsections.

### Control Flow:

The SIP Session Router receives SIP signalling messages from the SIP network. The SSR determines a mode of operation (e.g. proxy or back-to-back user agent (B2BUA)) which is being requested based on the SIP user agent that received the SIP message. If the received message is a new Request, the SSR will proceed to invoke the routing capabilities. If it is not a new request or it is a response to a previous request then the SSR bypasses the routing capabilities because the routing is determined by the Route header for requests and the Via header for responses. These two message types may still need to be normalized so that capability is invoked next.

If the SSR receives a new request, such as a SIP INVITE, then the routing capabilities are invoked. The SSR first determines if the routing address needs to be modified prior to invoking the routing function. The SSR can add, delete, or substitute digits to a routing address that is based on the traditional numeric phone number. The SSR can also add, delete, or substitute characters in text based routing addresses such as a URI.

Once the routing address has been prepared for routing, the SSR must determine if it will use an internal routing database or query an external routing database. If the SSR has been configured with an external routing server, then the SSR queries the external routing server for a list of routes to use for the new request. Otherwise, the SSR uses an internal routing database for determining the list of routes to use for the new request.

The final outcome of routing is to obtain a list of routes that can be used to complete the call. Each route in the list identifies a connected IP network element (or ‘node’) that the SSR can send the call to. The routes are processed in priority order from the highest priority to the lowest priority. The SSR can also apply time-of-day and routing percentage-based routing policies while determining the ordered set of routes.

After routing, the SSR can also manipulate routing addresses on the outgoing side of a new request. The SSR can add, delete, or substitute digits to a routing address that is based on the traditional numeric phone number. The SSR can also add, delete, or substitute characters in text-based routing addresses such as a URI.

Once a route has been selected from the route list the SSR must determine if the SIP signalling messages must be normalized based on the selected remote connected node. The SSR provides a scripting capability that is used to allow the SSR to add, remove, or modify SIP headers based on the capability and requirements of the remotely connected node.

Once the call has been routed and normalized, the SSR is ready to forward the signalling message to the selected route. If the SSR determines that the selected route is out-of-service, or if the connected node returns an error indication, then the SSR invokes the route advance function which means that it will pick or advance to the next route in the route list and normalize again and then forward the call to the connected node identified by that route. This process continues until the SSR successfully delivers the call to a connected node in the route list. It then completes any finite state machine processing required (if any) by the selected mode of operation. If the SSR tries all entries in the route list and encounters a failure condition for each one, the SSR will return an error indication to the connected node that originated the call and then completes any finite state machine processing required (if any) by the selected mode of operation.

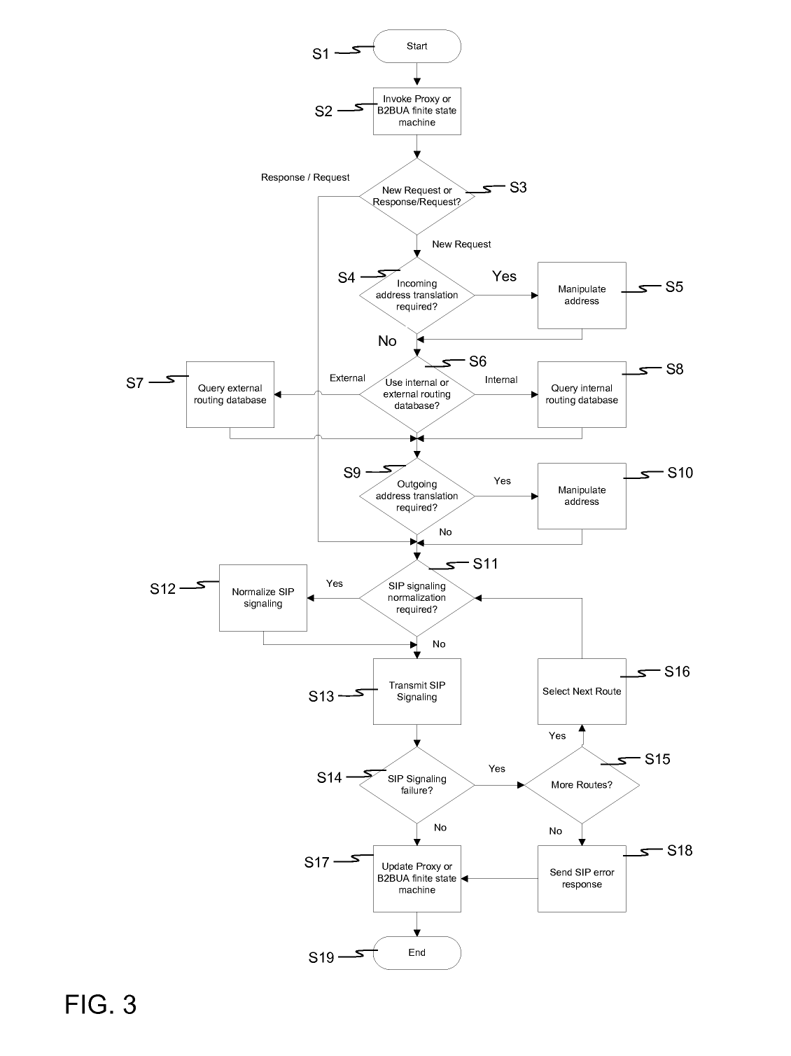

The flow chart in FIG. 3 illustrates the system level behaviour of SSR 100 when processing a SIP signalling message received from a SIP network element, for example a softswitch 102 in FIG. 2.

The process begins at step S1 and either a proxy or B2BUA finite state machine is invoked in step S2. In step S3, SSR 100 determines whether a received SIP signalling message relates to a new request or an existing response/request.

If it is determined in step S3 that the received SIP signalling message relates to a new request, then the process moves on to step S4. In step S4, SSR 100 determines whether incoming address translation is required.

If it is determined in step S3 that the received SIP signalling message relates to a previous request/response, then the process moves on to step S11.

If it is determined by SSR 100 in step S4 that incoming address translation for the SIP signalling message is required, then the address is manipulated by SSR 100 in step S5 before the process moves on to step S6.

If it is determined by SSR 100 in step S4 that incoming address translation for the SIP signalling message is not required, then the process moves directly on to step S6.

In step S6, SSR 100 determines whether an internal or an external routing database should be used for routing the SIP signalling message.

If it is determined by SSR 100 in step S6 that an external routing database is required for routing the SIP signalling message, then an external routing database is queried in step S7 and processing moves on to step S9.

If it is determined by SSR 100 in step S6 that an internal routing database is required for routing the SIP signalling message, then an internal routing database is queried in step S8 and processing moves on to step S9.

In step S9, SSR 100 determines whether outgoing address translation is required.

If it is determined by SSR 100 in step S9 that outgoing address translation for the SIP signalling message is required, then the address is manipulated by SSR 100 in step S10 before the process moves on to step S11.

If it is determined by SSR 100 in step S9 that outgoing address translation for the SIP signalling message is not required, then the process moves directly on to step S11.

In step S11, SSR 100 determines whether SIP protocol message normalisation is required for the SIP signalling message.

If it is determined by SSR 100 in step S11 that SIP protocol message normalisation is required, then SIP protocol message normalisation is carried out by SSR 100 in step S12 before the process moves on to step S13.

If it is determined by SSR 100 in step S11 that SIP protocol message normalisation is not required, then the process moves directly on to step S13.

In step S13, SSR 100 routes the SIP signalling message including any modifications/alterations made in steps S1 to S12 by transmitting it to the appropriate SIP network element in the network.

In step S14, if SSR 100 receives a SIP signalling failure message in relation to the SIP signalling message transmitted in step S13, then SSR 100 determines in step S15 whether it has knowledge of any more routes along which transmittal of the SIP signalling message can be attempted.

If at least one further route is identified in step S15, then a next route of the at least one further routes is selected in step S16 and the process returns to step S11.

If no further route is identified in step S15, then a SIP signalling error response message is transmitted to the SIP network element from which the SIP signalling message was received in step S18. SSR 100 then updates either the proxy or B2BUA finite state machine accordingly in step S17 and the process ends in step S19.

In step S14, if SSR 100 does not receive a SIP signalling failure message in relation to the SIP signalling message transmitted in step S13, then SSR 100 updates either the appropriate proxy or B2BUA finite state machine accordingly in step S17 and the process ends in step S19.

### Simultaneous Support for Stateless, Transaction Stateful, and Call Stateful Proxy Server:

The SSR provides tools for configuring the system to allow simultaneous operation of stateless, transaction stateful, and call stateful proxy servers.

The SSR maintains a routing database containing routing data for routing SIP signalling messages between SIP network elements in the network.

The SSR also maintains a group of simultaneously active modes including at least a SIP proxy server stateless mode and a SIP proxy server stateful mode. When the SSR receives a plurality of SIP signalling messages from SIP network elements in the network, the SSR routes at least some of the received SIP signalling messages with reference to the routing database according to a SIP proxy server stateless mode, and routes at least some of the received messages with reference to the routing database according to a SIP proxy server stateful mode.

In embodiments, the SSR maintains a group of simultaneously active modes including at least a SIP proxy server stateless mode, a SIP proxy server transaction stateful mode and a SIP proxy server call stateful mode. When the SSR receives a plurality of SIP signalling messages from SIP network elements in the network, the SSR routes at least some of the received SIP signalling messages with reference to the routing database according to a SIP proxy server stateless mode, routes at least some of the received SIP signalling messages with reference to the routing database according to a SIP proxy server transaction stateful mode, and routes at least some of the received SIP signalling messages with reference to the routing database according to a SIP proxy server call stateful mode.

This capability allows service providers to partition the signalling network for different classes of service when interconnecting to other service providers. For example, some interconnected service providers may prefer the more reliable stateful operation at a lower capacity and higher cost while other interconnected service providers may opt for less reliable stateless operation at a higher capacity and lower cost. This capability is accomplished on the SSR by provisioning of the desired proxy operation and integrated message handling functionality for each proxy type.

The SSR has an internal database referred to as the SIP Agent Profile which is associated with a SIP User Agent database entry. The SIP Agent Profile contains a parameter that allows the service provider to configure the corresponding SIP User Agent as a stateless, transaction stateful, or call stateful proxy server. If the service provider needs simultaneous support for more than one type of proxy server then it can set up multiple SIP Agent Profiles and SIP User Agents. The connected nodes forward their traffic to the corresponding SIP User Agent based on the reliability and capacity they have negotiated with the service provider.

Additionally, the SSR has integrated message handling functionality for stateless, transaction stateful, and call stateful proxy message handling. Stateless operation supports routing and normalization of SIP traffic, but the SSR does not maintain any state of a call or transaction and no state information is synchronized to the backup proxy. If the stateless proxy fails and the backup proxy takes over, new messages are routed independently of previously routed messages for the same call or transaction.

Transaction and call stateful operation also support routing and normalization of SIP traffic but these two modes of operation maintain the state of the transaction or call using a finite state machine that implements the proxy call model. Additionally, the transaction or call state is synchronized with the backup proxy. This allows the SSR to continue normal transaction or call stateful operation in the event of a primary proxy failure and activation of the backup proxy.

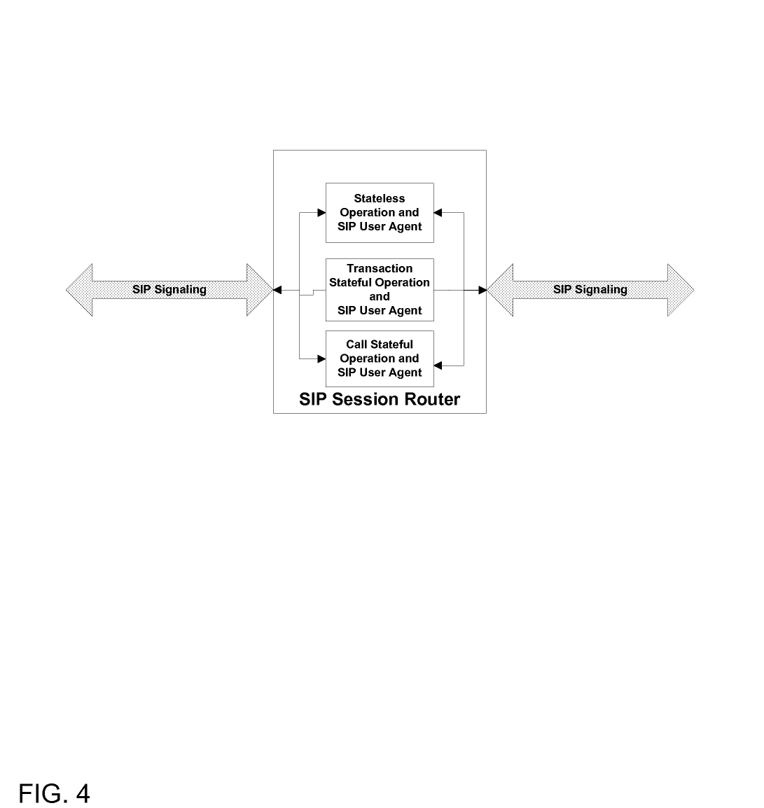

The simultaneous support for stateless, transaction stateful, and call stateful proxy server operation of the SSR described above is depicted in FIG. 4.

### Simultaneous Support of Proxy and Back-to-Back User Agent:

In embodiments, the SSR is capable of processing at least some received SIP signalling messages according to a SIP back-to-back user agent mode. The SIP back-to-back user agent mode may be a mode contained in the group of simultaneously active modes maintained by the SSR.

Some service providers need to take advantage of the numerous SIP Session Router features (e.g., normalization, SIP network, management, etc.) but prefer the SSR to operate as a B2BUA. Often this desire is due to not fully understanding the difference between B2BUA and proxy call handling. Other times the service provider has a valid reason for operating as a B2BUA.

Support for B2BUA operation is accomplished in a similar manner as the simultaneous support for stateless, transaction stateful, and call stateful operation. The SSR may be provisioned to enable the B2BUA user agent and integrated message handling functionality as in proxy operation. The SSR supports simultaneous operation of any and all proxy modes of operation alongside B2BUA operation.

In embodiments, the SSR is provisioned to handle any combination of one, two, three or four modes (stateless, transaction stateful, call stateful or B2BUA) simultaneously depending on the service provider's requirements.

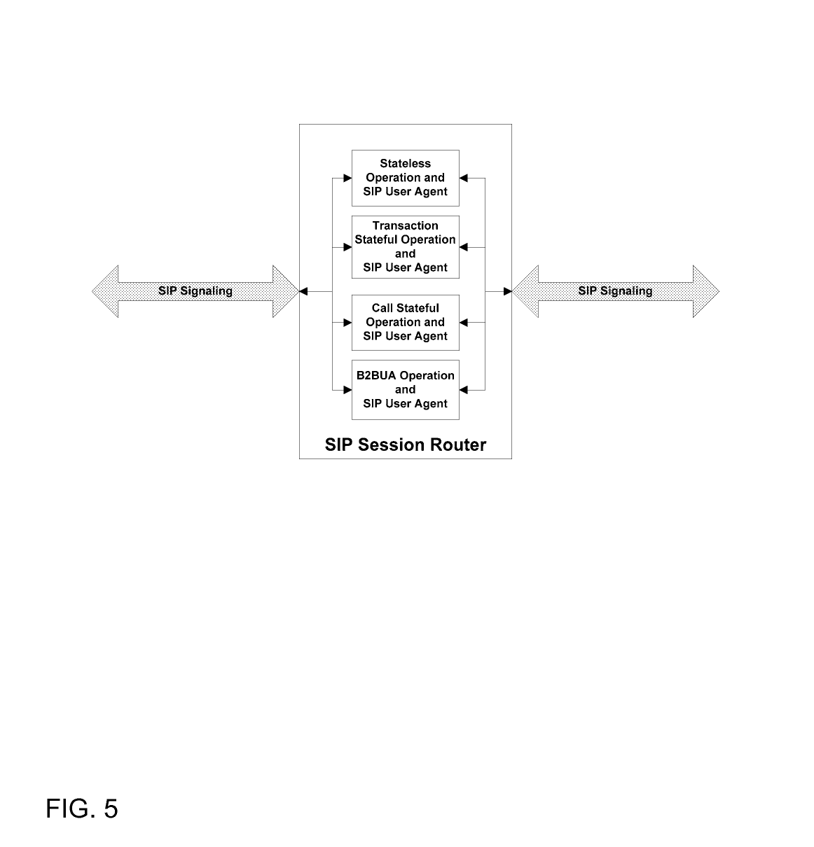

The simultaneous support for proxy and B2BUA operation of the SSR described above is depicted in FIG. 5.

The SIP Agent Profiles previously discussed are also used for B2BUA operation. The SIP Agent Profile contains a parameter that allows the service provider to configure the corresponding SIP User Agent as a B2BUA. If the service provider needs simultaneous support for B2BUA and proxy modes of operation then it can set up multiple SIP Agent Profiles and SIP User Agents.

B2BUA operation supports routing and normalization of SIP traffic and it maintains the state of the call using a finite state machine that implements the B2BUA call model. Additionally, the call state is synchronized with the backup B2BUA. This allows the SSR to continue normal call operation in the event of a primary B2BUA failure and activation of the backup B2BUA.

### SIP Normalization for SSR Message Traffic:

Normalization is defined as the capability to modify SIP messages to account for the different variants of SIP implementation on the SIP based network elements. The SIP Session Router provides the capability to normalize SIP messages to account for discrepancies in the level of SIP protocol compliance between different network equipment vendors' SIP implementations. Some incompatibilities are also introduced by implementations that contain proprietary SIP headers, or use existing headers for non-standard uses. For example, one network equipment vendor may add proprietary headers in the SIP messages that may need to be removed before forwarding that SIP message to another vendor's network equipment.

Quite often the discrepancies in the level of SIP protocol compliance are not discovered until the SSR is deployed in the service provider's test lab and connected to the real SIP network elements that are also deployed in the service provider's live network. Once a discrepancy is discovered, the service provider needs a fast way of changing the behaviour of the SSR so that it compensates for the SIP protocol discrepancy. Ideally, such changes should not involve compiled code changes; hence the importance of providing a mechanism that allows scripting of SSR behaviour and protocol handing.

The SSR provides a scripting language that allows the service provider to easily change the behaviour without going back to the SSR vendor for a time consuming software change and subsequent build and release cycle. The SSR supports normalization for all proxy modes and back-to-back user agent mode. The SSR provides this capability as follows:
a) capability to normalize all, a subset, or none of the SIP messages handled by the SSR;
b) scripts that provide a finite state machine (FSM) implementation of proxy and B2BUA call processing logic;
c) scripts can add or remove protocol message information elements for binary format protocols;
d) scripts can add or remove headers, fields, or strings for text based protocols.
e) scripts can modify the content or value of protocol message parameters by the following methods: 1) hard coded values, 2) provisioned values, or 3) query external databases for the values;
f) regular expression processing of headers, fields and strings within the protocol;
g) new call processing states can be added to the finite state machine to perform unanticipated call processing logic;
h) for performance reasons, call processing state logic is executed in the compiled infrastructure of the SSR unless the same call processing state exists in the script, i.e. the script-based FSM state handler overrides the compiled FSM state handler.
i) scripts are text-based files that can be modified by the service provider using any available editor.
j) text-based scripts are loaded into the SSR and converted to run time executable code so that run time interpretation of the script is not required.

### Database Queries on Proxy Server Calls:

Many service providers have decided to deploy routing information in external network based centralized databases. However, the service providers still want to take advantage of other SRR features such as normalization or SIP network management but not necessarily take advantage of the internal routing capabilities of the SSR.

This capability is supported by provisioning the SSR to make a binary decision between an external routing database and an internal (SSR-based) routing database. If the system is provisioned with a server for external routing (for example an Electronic Number Mapping System (ENUM) server) then the SSR launches a query to the external routing database for routing instructions. If an external server is not provisioned, then the SSR uses the internal routing database. If the query to the external routing database fails, then the SSR will use the internal routing database instead.

The implementation of external database routing provided by the SSR ensures that such calls may also be proxied via the SSR. Alternatively, for calls where normalization or management is unnecessary or undesirable, the SSR may simply provide a SIP redirection service after the query to the external routing database. The SSR provides the ability to function in both configurations based on the routing rules implemented.

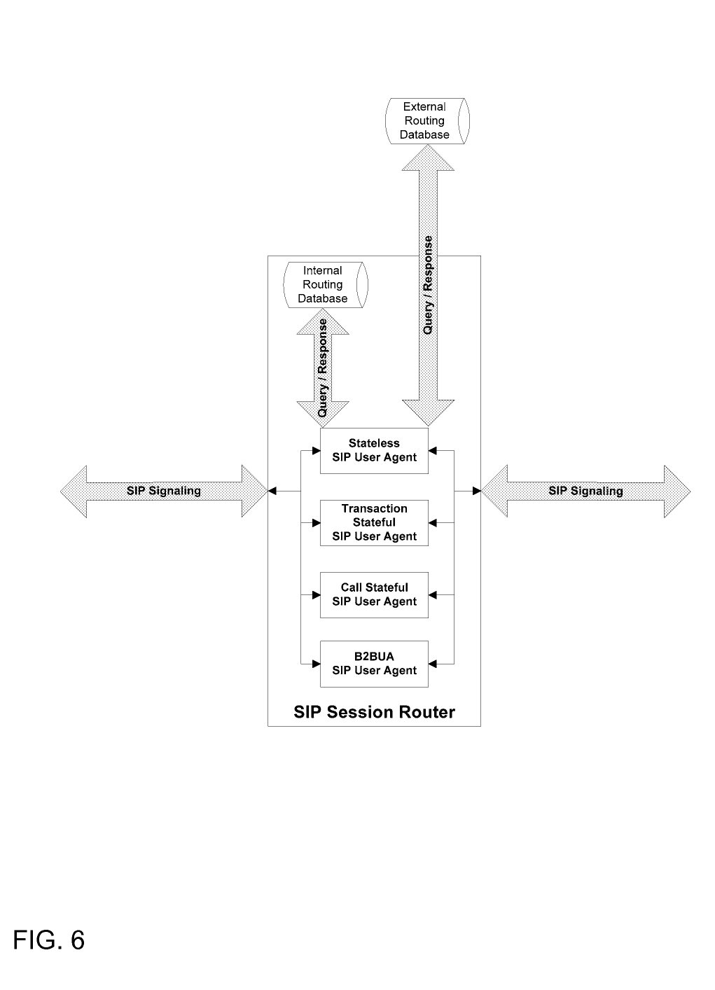

The internal/external routing database operation of the SSR described above is depicted in FIG. 6

### Flexible IP Transport Types and IP Addressing:

Service providers have a mixture of SIP based network elements that have been deployed over time as the SIP standards have evolved. Some of these SIP based network elements require the User Datagram Protocol (UDP) for the IP transport layer carrying the SIP signalling, others require Transmission Control Protocol (TCP), and others are starting to use Stream Control Transmission Protocol (SCTP).

The SSR provides this capability by provisioning an internal database referred to as the Remote Node database with the preferred transport type (TCP, UDP, SCTP, or Transport Layer Security (TLS)) of the remotely connected node. Additionally, the proxy finite state machines have inherent knowledge of the rules for interworking one transport type with another. For example, if an incoming call arrives at the SSR with a transport type equal to TLS, then the outgoing call should also use TLS. If the outgoing remote node is provisioned with a preferred transport type of TCP, then the SSR will reject the incoming call that used TLS.

Embodiments comprise processing, for example at an SSR, SIP signalling messages in a telecommunications network comprising a plurality of SIP network elements. A database containing preferred data transport types of one or more remote SIP network elements is maintained. A plurality of SIP signalling messages from one or more remote SIP network elements are received and at least some of the received SIP signalling messages are routed with reference to the database containing preferred data transport types.

Not only are service providers migrating their networks towards VoIP and SIP signalling but they are also transitioning their networks from Internet Protocol version 4 (IPv4) to Internet Protocol version 6 (IPv6) transport and addressing. This network migration takes several years to accomplish and the net result is that there is a transition period for several years where some of the SIP based network elements support IPv4 and others support IPv6.

The SSR provides support for IPv4 and IPv6 by provisioning the SIP User Agent database of the SSR with two URIs. One URI has an associated IPv4 address and the other URI has an associated IPv6 address. The SSR also provisions the URI of the remotely connected node with either an IPv4 or an IPv6 address depending on that remote node's preference. If a call arrives at the SSR via IPv4 and terminates to a connected node that is configured for IPv6, then the SSR uses an IPv6 URI address in applicable SIP headers that contain the URI of the SSR destined for the IPv6 connected node. Likewise, when a call arrives at the SSR via IPv6 and terminates to a connected node that is configured for IPv4, then the SSR uses an IPv4 URI address in all applicable SIP headers that contain the URI of the SSR destined for the IPv4 connected node. The underlying transport used by the SSR for the SIP signalling is either IPv4 or IPv6 to match the type of IP address the SSR is using in the SIP signalling messages for a particular call.

Embodiments comprise processing SIP signalling messages in a telecommunications network comprising a plurality of SIP network elements. A database is maintained which contains both SIP Uniform Resource Identifiers (URIs) associated with IPv4 network addresses and different SIP URIs associated with IPv6 network addresses of one or more remote SIP network elements. A plurality of SIP signalling messages from one or more remote SIP network elements are received and at least some of the received SIP signalling messages are routed with reference to the database.

### SIP Signalling Network Management

The SSR provides methods for managing SIP traffic flow through the service provider's network. If there are failures in the SIP signalling network, the SSR is capable of directing traffic away from failed network equipment. For example, the SSR detects when connected systems have failed and forwards traffic on alternative routes. Additionally, the SSR collects statistics on SIP signalling performance and takes recovery actions based on those statistics and/or these may be used for offline traffic studies. The network management features of the SSR are described in the following subsections.

### External Network Overload Controls:

The SSR provides a mechanism to shed, i.e. discard, SIP signalling traffic if it becomes overloaded. In such embodiments, the SSR discards one or more received SIP signalling messages during message overload conditions.

An overload condition can be determined by monitoring the percentage of CPU utilization and memory utilization by the SSR. When the utilization exceeds a predetermined ‘high water’ threshold the SSR begins to reject a percentage of the new incoming traffic until the utilization is reduced to a predetermined ‘low water’ threshold. If the utilization continues to rise then the SSR eventually rejects 100% of the new incoming traffic until the low water threshold is reached. During the overload condition the SSR may respond to incoming SIP traffic with SIP 486 Busy Here error response signalling messages.

### SIP Traffic Metrics:

Since the SSR is centralized in the core of the SIP network and handles a majority or all SIP traffic flowing through the network, it becomes an ideal location to monitor the SIP traffic and produce metrics that the service provider can use to improve the network engineering of their SIP network.

In embodiments, the SSR generates, at least on the basis of one or more received SIP signalling messages, one or more SIP signalling message traffic metrics.

In embodiments, the SIP Session Router provides the following SIP network and traffic related metrics:
a) The SSR measures the latency of responses from each connected node and issues an alarm when the latency exceeds a predetermined threshold. The SSR does not measure the response latency for every SIP transaction to a connected node because the system overhead would be significant. Instead, it measures the latency to each connect node 1 out of N SIP transactions where N is configurable for each connected node. This data is collected for example every 15 minutes over a 24 hour period. This metric helps the service provider to identify SIP nodes that are not performing up to specification especially during peak traffic hours. The service provider can then take action in the SIP network to improve the performance of the connected node such as upgrading the hardware, deploying another node, or routing some of the traffic to a node with more capacity.
b) The SSR maintains a metric of the total VoIP signalling and media bandwidth used between two connected nodes based on SIP signalling messages, the type of codec engaged for the VoIP call, and the duration of the call. This data is maintained between each combination of two connected nodes provisioned on the SSR. The bandwidth for signalling and media are calculated separately. The data is also maintained separately in each direction for a pair of connected nodes. This data is collected for example every 15 minutes over a 24 hour period. This metric helps the service provider to identify over-utilized or under-utilized IP network equipment such as routers and media gateways. The service provider can then take action to reconfigure and re-engineer the underlying IP network equipment before a severe traffic outage occurs.

### APIs for Connected Applications:

Service providers often develop new and innovative applications that facilitate management, operation, and expansion of their networks and corresponding network equipment. For example, the service provider may want to develop an application that monitors the percentage of calls answered and the answer delay time for the different switching nodes connected to the SSR to identify nodes that are not performing as expected. Based on this information, the service provider can make decisions about adding more switching equipment or changes to the routing of traffic to offload poorly performing nodes.

In embodiments, the SSR provides Application Programming Interfaces (APIs) that allow the service provider to develop applications that monitor traffic as it is switched by the SSR. The SSR should provide multiple APIs so that the service provider can develop the external application in their preferred programming environment and language.

In embodiments, the SSR supports the following popular APIs, but other APIs are also possible: C++, Java, Web Services, and Simple Network Management Protocol (SNMP).

The APIs allow the service provider application to be notified of key call processing events on the SSR such as the call initiation event (SIP INVITE), the answer event (SIP 200 OK), and/or the call disconnect event (SIP BYE). The application can also retrieve traffic statistics, Call Information Records (CIR) for B2BUA calls, or Proxy Information Records (PIR) for proxy calls.

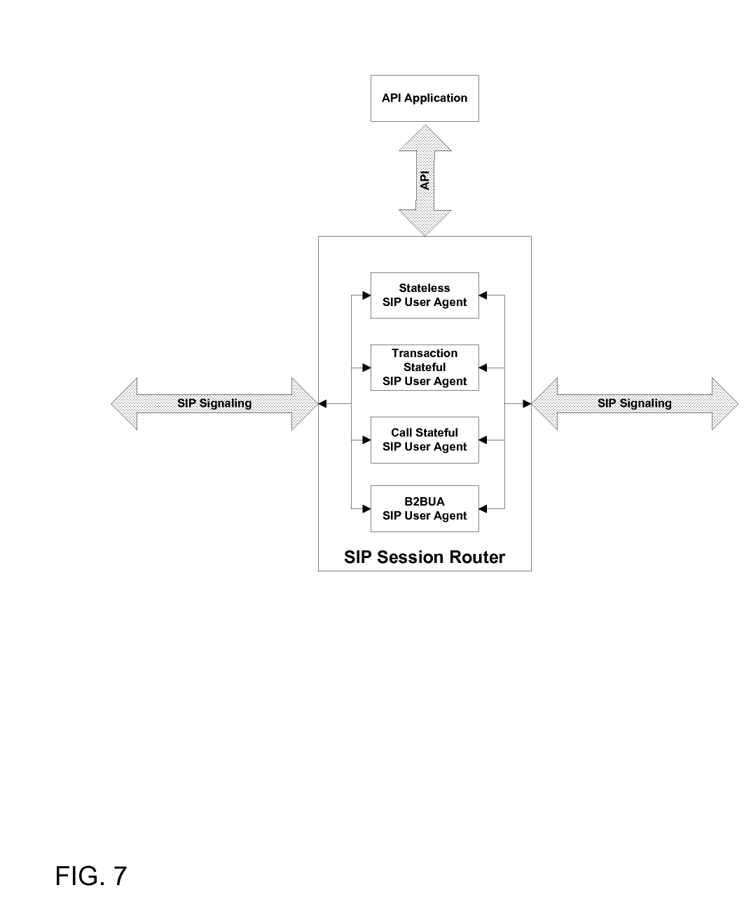

The API provision of the SSR described above is depicted in FIG. 7.

### Proxy Information Records (PIR):

The SSR generates event based session detail records for SIP traffic referred to as Proxy Information Records (PIR). The PIRs are stored on the SSR and provide a detailed summary of the SIP events for a particular SIP session. This information is viewable by the service provider for troubleshooting purposes and can even be transferred to a back office system for billing or traffic studies analysis.

In embodiments, the SSR generates, at least on the basis of one or more received SIP signalling messages, one or more event based session detail records.

PIR events contain the following data:

i. Date and time of the event;

ii. Direction indicator of the message event—incoming or outgoing;

iii. SIP Call ID.

SIP request method events also contain the following data:

i. Identification of the remote connected node that sent or received the SIP message;

ii. Identification of the locally provisioned SIP user agent that sent or received the SIP message;

iii. Identification of the proxy type used (stateless, transaction stateful, or call stateful);

iv. SIP From header;

v. SIP To Header;

vi. Indication of record route status.

SIP response method events also contain the following data: response method indicator (302, 180, etc.)

### Availability Monitoring of Connected Nodes:

The SSR monitors the availability of the connected nodes so that it can determine when a connected node has gone out of service. This feature coupled with the SSR routing features provides maximum reliability for traffic handling required by the service provider. The SSR uses the SIP Options or the SIP Register message to periodically query the health status of the connected nodes. If a connected node replies to the SIP message with a normal response then the SSR continues to offer traffic to that connected node. If a connected node replies to the query with an error message or does not reply, the SSR marks the connected node out of service and begins to use alternate route choices for a particular SIP call.

### Service Assurance:

The service provider needs visibility into the real time signalling scenarios in the network for troubleshooting purposes. Therefore, service assurance systems are employed that connect to the core network elements and collect signalling messages that are echoed to the service assurance system in real-time. A service assurance system provides a flexible signalling message display mechanism that allows the operators to view all or a subset of the signalling messages based on one or more filtering criteria entered by the operator.

In embodiments, the SSR is deployed with a service assurance server that provides the capabilities described above. The SSR software has been instrumented with intelligence that allows all signalling messages to be echoed to the service assurance server where they are stored and made available for display and troubleshooting purposes.

In embodiments, service assurance functionality is provided within the SSR.

### SIP Service Node

In addition to the SSR, the following products can be employed in the service provider's network:
a) Service Broker (SB)
b) Session Centralization and Continuity Application Server (SCC AS)
c) Media Resource Broker (MRB)

These products are also based on next generation signalling protocols such as SIP and they are typically centralized within the core network. Since these products are still emerging in the network, the service providers often have a need to deploy more than one product and these are usually operating at a low capacity in the early stages of deployment. To minimize the overall capital equipment and operational cost, the service provider should deploy these network functionalities on a common platform. As the traffic grows, the individual network functionalities can be deployed on separate hardware platforms with software updates and reconfiguration.

These other network entities may also require the assistance of the SSR for SIP normalization, as they are SIP elements themselves.

The SSR provides the capability to package other SIP based network elements on the SSR platform. For example, a Service Broker can be collocated on the SSR platform to minimize capital and operational expense for the service provider. Deploying multiple applications on a single platform allows the service provider to provide a single point-of-presence to the rest of the SIP network thus reducing its IP network footprint and minimizing operational expense.

When the SSR hosts other SIP based network elements, the combined network element is referred to hereinafter as a SIP Service Node (SSN).

### SIP Session Router Plus Service Broker:

A Service Broker connects next generation networks to legacy applications and legacy networks to next generation applications. In most applications of Service Broker technology the signalling interworking required for the service is SIP to Intelligent Network or vice versa. An example of Service Broker technology is connecting a VoIP Softswitch to a Freephone Service Control Point (SCP). The softswitch sends a SIP INVITE to the Service Broker which converts it to the appropriate Intelligent Network message and forwards it to the SCP. The SCP translates the Freephone number into the actual number and sends it back to the Service Broker in an IN response message. The Service Broker converts the Intelligent Network response into a SIP 302 Moved Temporarily message which is forwarded to the softswitch. When the softswitch receives the 302 message it extracts the translated Freephone number and places it into a SIP INVITE message which it then forwards to the SIP Session Router which routes, normalizes, and forwards/proxies the INVITE to its final destination.

Packaging an SSR with a Service Broker provides the service provider with a cost efficient SSR Service Node for SIP based services that rely on routing of SIP traffic and connection of SIP applications to legacy networks or legacy applications to SIP networks. Since both capabilities rely heavily on SIP signalling, deploying the SSR and SB in a centralized network element also reduces operational expense.

The SSR allows the service provider to provision both SSR and SB capabilities on the same platform with each application using a common management capability. The service provider can provision separate SIP user agents for SSR and SB applications. The connected SIP based systems direct their traffic to the SSR or SB by selecting the correct SIP user agent. Optionally, the connected SIP based systems may also direct all traffic towards the SSR user agents and it will in turn forward the appropriate traffic to the SB using its routing capabilities.

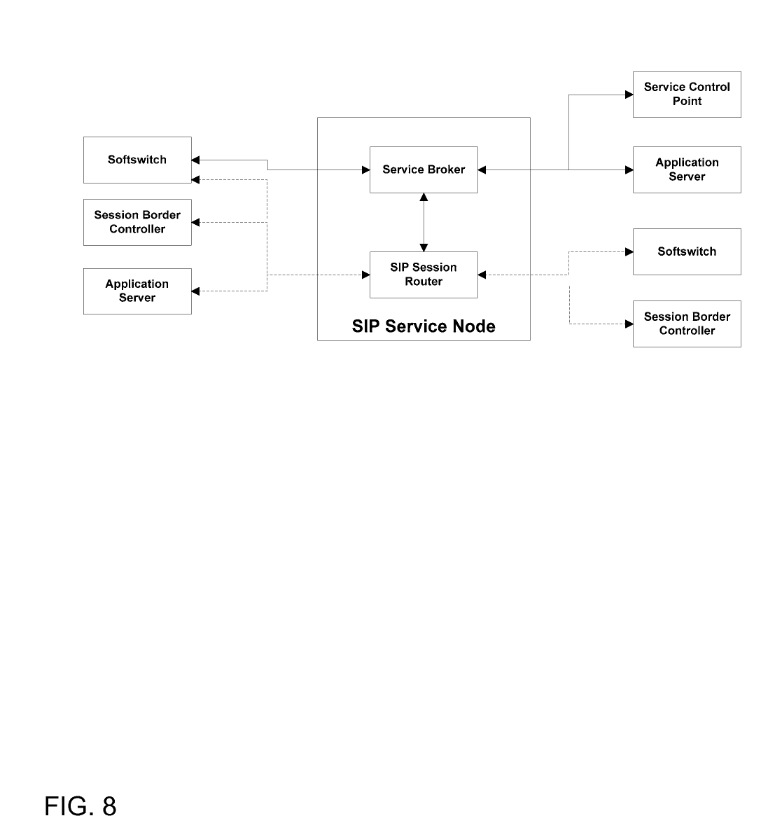

In embodiments, an SSR provides service broker functionality in relation to at least some received SIP signalling messages. The service broker operation of the SSR described above is depicted in FIG. 8.

### SIP Session Router Plus Session Centralization and Continuity Application Server:

Similar to a Service Broker, the Session Centralization and Continuity Application Server (SCC AS) connects legacy wireless networks to next generation applications. In most applications of SCC AS technology, the signalling interworking required for the service is Intelligent Network signalling followed by SIP to SIP or any legacy Time Division Multiplexing (TDM) based signalling (e.g., Integrated Services Digital Network User Part (ISUP)) to SIP. An example of SCC AS technology is connecting a wireless gateway softswitch to a Terminating Services Application Server. The wireless gateway softswitch sends an Intelligent Network query to the SCC AS which in turn redirects the softswitch to forward the call to a special temporary number which results in the softswitch sending the call directly back the SCC AS. The SCC AS correlates the new incoming SIP call with the previous handled Intelligent Network (IN) query, merges data from the IN query with the SIP data, and forwards that call to the application server for terminating services treatment.

Packaging a SSR with a Session Centralization and Continuity Application Server provides the service provider with a cost efficient SSR Service Node for SIP based services that rely on routing of SIP traffic and connection of wireless networks to SIP based application servers. Since both capabilities rely heavily on SIP signalling, deploying the SSR and SCC AS in a centralized network element also reduces operational expense.

The SSR allows the service provider to provision both SSR and SCC AS capabilities on the same platform with each application using a common management capability. The service provider can provision separate SIP user agents for SSR and SCC AS applications. The connected SIP based systems direct their traffic to the SSR or SCC AS by selecting the correct SIP user agent. Optionally, the connected SIP based systems may also direct all traffic towards the SSR user agents and it will in turn forward the appropriate traffic to the SCC AS using its routing capabilities.

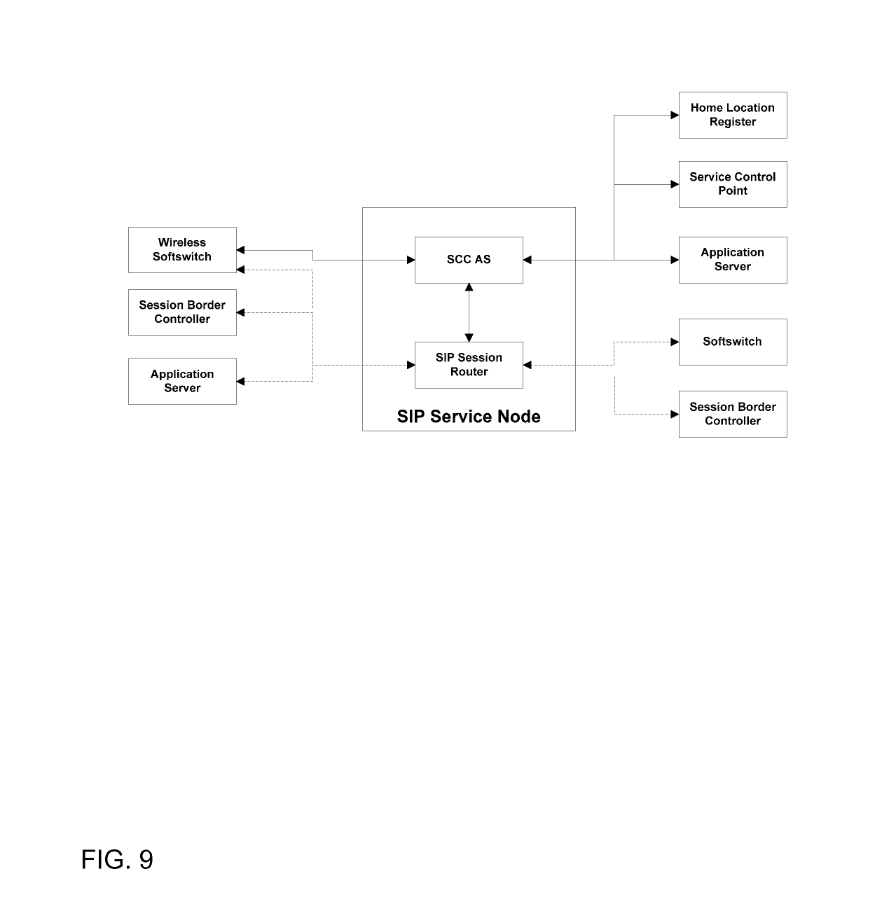

In embodiments, an SSR provides session centralisation and continuity application server functionality in relation to at least some received SIP signalling messages. The session centralisation and continuity application server operation of the SSR described above is depicted in FIG. 9.

### SIP Session Router Plus Media Resource Broker:

Service providers have been deploying media server or media resource platforms for a number of years. Typically, a service provider deploys a new service on an application server. If the service required access to the media or bearer then the application server came with a connected media server.

A common deployment model is for application servers to have dedicated media servers to deliver bearer (e.g. voice) services, such as recording messages, playing prompts, etc. As multiple applications are deployed, the service provider often finds that there is excess media server capacity. Much of this capacity is there to deal with peak traffic, which, depending on the application, may not coincide with any other peak load of any other application. Ideally, a single pool of media resources would exist in the network for everyone to utilize. IMS addresses some of this issue by specifying the media resource control function or MRCF. In order to provide additional resiliency and fault tolerance, 3GPP added a new functional entity, the Media Resource Broker (MRB) as an application layer capability.

Early deployments of media servers used media control protocols such as H.248 or Media Gateway Control Protocol (MGCP) for control of the media server. More recent media server deployments use SIP as the control protocol. As a result, the service provider is left with an assortment of media servers with different media control methods.

As more and more services are deployed, the service provider ends up with many different application servers and associated media servers that are often underutilized in terms of capacity.

The MRB provides an efficient solution to the service providers in relation to at least the issues described above. The MRB provides interworking of SIP or media control protocols coming from the application servers to media servers again using SIP or a media control protocol. Additionally, the MRB can allow media servers to be shared between connected application servers providing improved media server utilization and reduced capital and operational expense for the service provider.

Packaging an SSR with a Media Resource Broker provides the service provider with a cost efficient SSR Service Node for SIP based services that rely on routing of SIP traffic and media associated with SIP signalling. Since both capabilities rely heavily on SIP signalling, deploying the SSR and MRB in a centralized network element also reduces operational expense.

The SSR allows the service provider to provision both SSR and MRB capabilities on the same platform with each application using a common management capability. The service provider can provision separate SIP user agents for SSR and MRB applications. The connected SIP based systems direct their traffic to the SSR or MRB by selecting the correct SIP user agent. Optionally, the connected SIP based systems may also direct all traffic towards the SSR user agents and the SSR will in turn forward the appropriate traffic to the MRB using its routing capabilities.

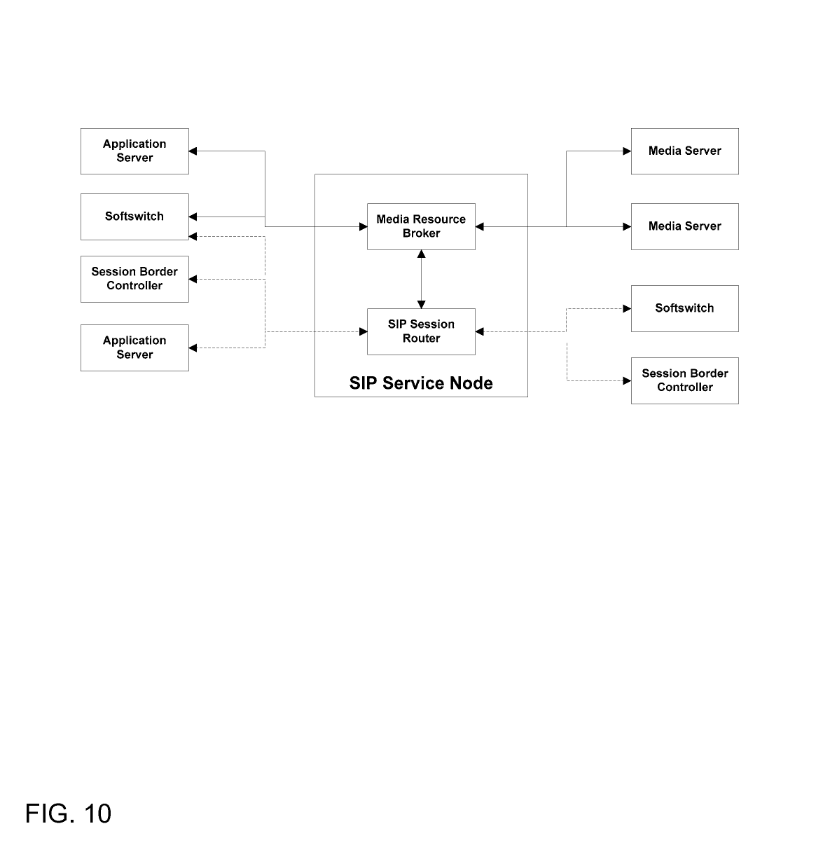

In embodiments, an SSR provides media resource broker functionality in relation to at least some received SIP signalling messages. The media resource broker operation of the SSR described above is depicted in FIG. 10.

In embodiments, the SSR implements MRCF/MRB functionality to allow the pooling of media servers into a common resource to be used by new and existing application servers. From a SIP application server point of view, the SSR appears to be a media server accepting SIP INVITEs and negotiating media streams as needed. The SSR is then responsible for maintaining a view of available media servers and load balancing traffic across all available resources. In addition, media server failures are hidden from view from the rest of the network, enhancing network uptime and minimizing any service downtime.

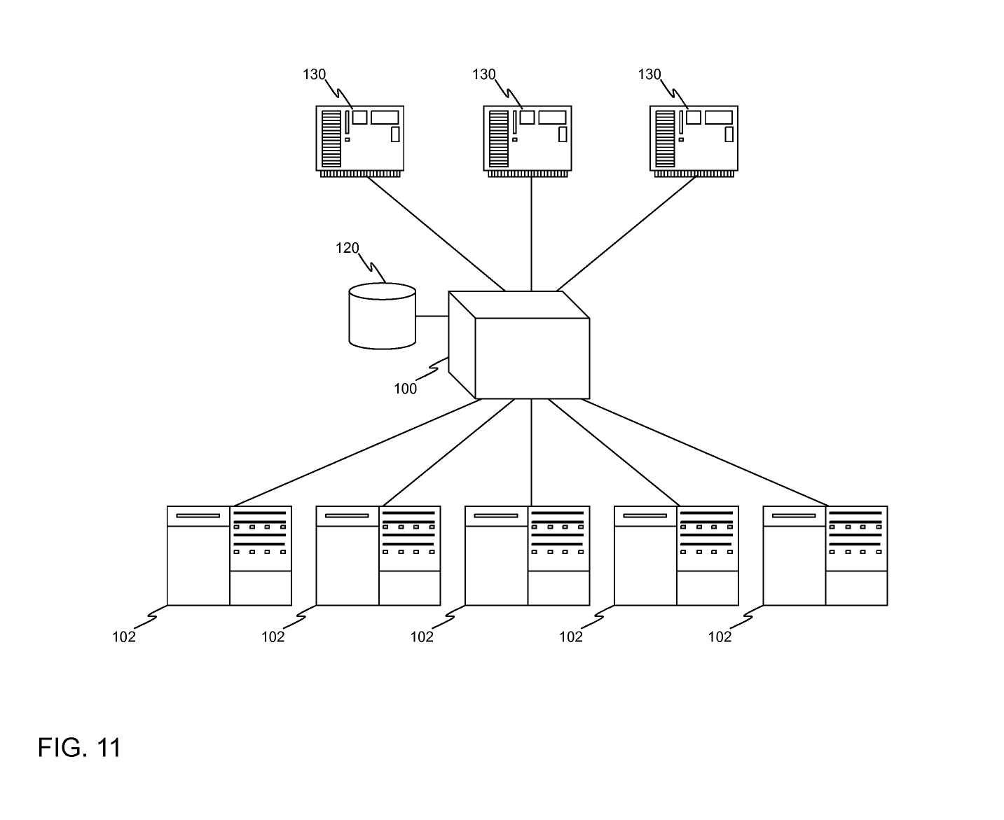

Such deployment of an SSR 100 (with routing database 120) providing media server brokering functionality in relation to a number of softswitches 102 and media servers 130 is depicted in FIG. 11.

### Enhanced Routing

The SSR provides enhanced routing capabilities that solve network routing administration and reliability issues for the service provider. These capabilities are described in the following subsections.

### Internal or External Routing Database:

Service providers are increasing the number of network elements in their SIP networks which results in replication of routing information in all of the network connected SIP based switching systems. As the service providers deploy more and more SIP based systems, maintaining the routing databases becomes cumbersome and error prone. The SSR provides a solution for this problem by allowing the service providers to centralize the routing database in the SSR thus eliminating the multiple copies of the routing database distributed throughout the network of SIP systems. This issue can be addressed with two different approaches:
1) Centralize the routing database locally on the SSR system.
2) Centralize the routing database on an external server and query the server from the SSR. For this case, the SSR is primarily used for SIP normalization since the routing information is provided from an external database.

The SIP Session Router determines the routing database to use by provisioning. If the external server is provisioned on the SSR, then the SSR queries the external server for routing information. If the external server is not provisioned on the SSR then the SSR access its locally stored routing database. The SSR can support any convenient query protocol such as ENUM or Intelligent Network signalling.

### Route Advance:

Historically, switching systems such as Class 4/5 switches, softswitches, or mobile switching centres (MSCs) provided a call routing capability that determined a list of possible routes for forwarding a call into the network. The switching system would try the first route in the list and if that route was out of service or the signalling failed to that route then the switching system would “route advance” and select the next route to complete the call.

With the advent of SSR technology, the switching systems no longer contain the entire routing database so they cannot determine a complete route list. Furthermore, they cannot determine if a route failed and that a route advance operation is now required. Since route list determination is now the responsibility of the SSR, the SSR assumes responsibility for processing the call based on the ordered list of routes (except for stateless proxy operation which generally does not support route advancing) and determining that a route advance operation is required when higher priority routes are unreachable. The SSR provides the route advance capability as described in the following paragraphs.

The Proxy FSM requests a route from a routing function on an incoming INVITE message. The routing function returns a “Routing Context” to the Proxy FSM. This routing context contains the Route List ID, the current index in the route list from which the route was selected, and the index of the last index that should be searched if rerouting is necessary. For FIRST AVAILABLE operation, the last index is the last entry in the route list, but for ROUND ROBIN operation, it could be any index into the route list (usually, where the ROUND ROBIN algorithm started from).

The routing function will not select routes that are out-of-service; either because they are locked, have reached their capacity, or are disabled due to a heartbeat timeout. The routing function will therefore “route advance” past these routes.

The Proxy FSM keeps the routing context around in case it gets a 480, 500, 501, 502, 503, or 504 SIP signalling message as a response to the outbound INVITE. If it does receive such a response, it will route advance by sending a Reroute message to the routing function and passing it the routing context, which is used to select a new route based on where the routing algorithm left-off last time. A modified routing context is returned to the proxy FSM with the new results. This process continues until a successful INVITE has occurred or until the route list has been exhausted.

### Route on Specific SIP Message Information:

In the past, telephone calls were routed through the PSTN by determining routes from routing databases that were accessed by database keys constructed from the digits of the destination phone number. For example, in North America, interoffice telephone calls were typically routed based on the 3 digit Numbering Plan Area (NPA) code or 6 digit NPA plus exchange id code referred to as NPA-NXX.

Currently, and continuing into the future, more and more telephone calls are being handled as Voice over Internet Protocol (VoIP) calls utilizing SIP signalling. SIP based VoIP calls are usually routed based on information in the Request URI or some other SIP header in the INVITE message. Typically, these SIP headers may contain a traditional telephone dialing number or alternatively they contain a SIP Uniform Resource Identifier (URI) of the form sip:user:password@host:port;uri-parameters?headers. Service providers are slowly transitioning from routing based on traditional telephone numbers to routing based on SIP URIs. During this transition, the network must be capable of routing on a telephone dialing number or a SIP URI. The dilemma for the service provider is that many legacy switching systems do not support routing based on URIs.

The SSR solves this problem for the service provider by supporting a routing capability that can be accessed by a traditional telephone dialing number, a SIP URI or other SIP header, or a portion of a SIP URI or other header. The innovative SSR routing database architecture is described in the following paragraphs.

The Service Broker's routing capabilities are controlled by three tables:

i. Translation Sequence

ii. Route Table

iii. Route List

Routing is invoked when call processing attempts to select an outgoing route for an outbound call. If the call is not directed from an external application, a field (‘/translation’) in the inbound endpoint pool is used to point to a particular translation sequence.

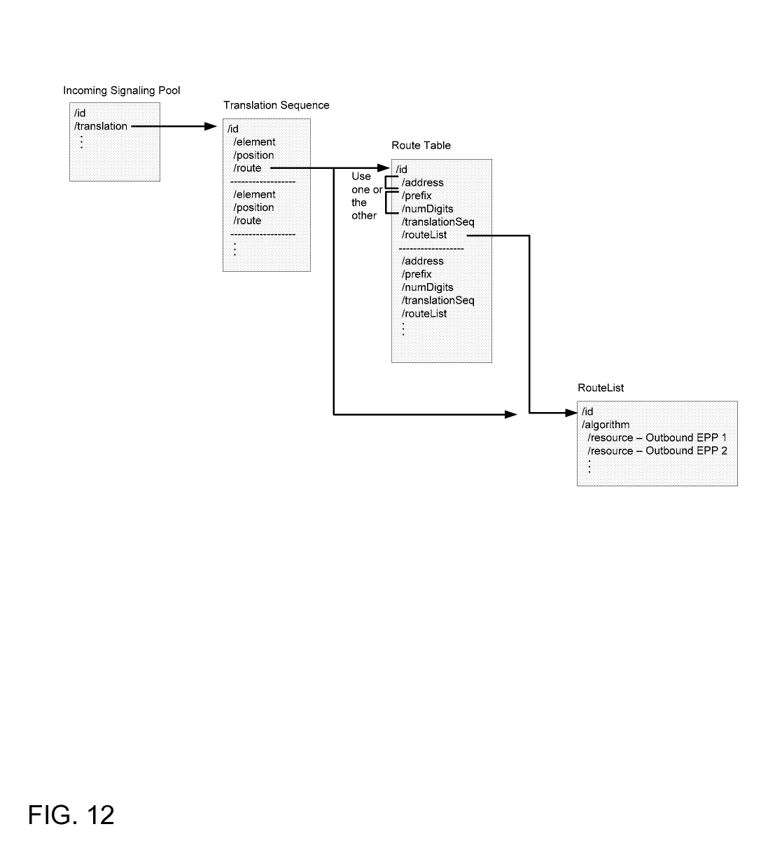

FIG. 12 depicts how the above fields interrelate.

The translation sequence provides a way to cause different values of signalling information in the incoming call to direct an outbound call to different routes. Each translation sequence can store a set of different signalling entries to match. Attempts are made to match each entry in a specified order. When a match is made, the corresponding /route field is used to determine what the next step is to determine an outbound route.

Each translation sequence uses a set of three fields: Element; Position; and Route.

The ‘element’ indicates what data in the incoming signalling information to match against. The ‘element’ contains a combination of which field (e.g. calling number, called number, SIP URI, etc.) to match, and what data (a regular expression) that specifies what part of that field to match (e.g. domain of the SIP URI, or hostname of the SIP URI).

The table below lists some currently available elements that can be matched against and a description of what they match.

| Element | Description |
|---|---|
| *CPN | Called party number |
| *CPN_USER | User part of called party number |
| *CPN_HOST | Host part of called party number |
| CIN | Calling party number |
| *CIN_USER | User part of calling party number |
| *CIN_HOST | Host part of calling party number |
| OCN | Original called number |
| *OCN_USER | User part of original called number |
| *OCN_HOST | Host part of original called number |
| REQ_URI | Request URI |
| REQ_URI_USER | User part of request URI |
| REQ_URI_HOST | Host part of request URI |
| TO_URI | To URI |
| TO_URI_USER | User part of ‘to’ URI |
| TO_URI_HOST | Host part of ‘to’ URI |
| FROM_URI | From URI |
| FROM_URI_USER | User part of ‘from’ URI |
| FROM_URI_HOST | Host part of ‘from’ URI |
| CC | Country Code |
| CAC | Carrier identification digits |
| PERM | Always matches and selects this entry |

*Note that CPN, CIN and OCN—(Called party number, Calling party Number, and Original Called Number) from a SIP originator is populated with a numeric value if the SIP URI was of Tel: format, or of a SIP format of ‘number’ @host. So the USER and CPN elements for these will not actually contain any data.

The ‘position’ field specifies the order matching that will be attempted for all entries within one translation sequence. Entries are attempted in ascending order—i.e. the entry with the lowest ‘position’ number will be tried first, followed by the next highest, etc. The Caller Line Identifier (CLI) prohibits two entries with the same ‘position’ number from being entered.

The last field in the translation sequence is the ‘route’. This field normally points to a particular route table which contains the patterns to match against. The entries in that route table are compared against the data specified in this translation sequence. If one matches, the routing process references fields within that route table to continue processing the route.

The ‘route’ field in the translation sequence can also point directly to a route list. If ‘route’ points to a Route List, no matching is attempted; processing immediately uses the endpoints/UAS (user agent server) specified in the Route List. This is useful if it is desired to route all traffic from one endpoint pool/UAS to another specific endpoint pool/UAS.

The Route Table contains sets of information to match against, along with information on what to do next if a match is successful.

The Route Table has two fields that can be used to store the matching string. The ‘address’ field is used for character based fields (e.g. URIs) and uses a string comparison match. The ‘prefix’ field (along with ‘numDigits’) is used to match telephone numbers, and uses a fast numeric tree matching system. The most specific string of digits found in a route table entry that matches the incoming number will be used to determine the ‘route’ used. For the ‘address’ field, the regular expression dictated by the translation table ‘element’ will return a particular string of digits (e.g. user name or host name) that must exactly match a string provisioned in the route table. In either case, if no matches are found in the route table, the next entry in the translation sequence is attempted.

If a match is found against the appropriate field, then the /routeList or /translationSeq field is used; typically only one of these fields would be populated. The /routeList references a particular route list where outbound resources (SIP User Agents, ISUP Endpoint Pools, etc) are listed. If the /translationSeq is populated, the process could start again with the specified translation sequence. This would give the capability of routing based on two signalling elements (e.g. Calling Number starts with 972424, and the Called Number is 800766).

The Route List contains sets of resources to be used to complete that call. These are typically a resource pool (i.e. a SIP Remote Node) or set of resource pools.

The /algorithm parameter controls the selection between the resources in the route list.

First-Available always selects the first item in the route list, if it is available for traffic.

Round-Robin selects each item one after the other.

### Scalable Architecture

Service provider requirements for SIP network capacity vary widely depending on their individual plan and timeframe for transitioning to a SIP based signalling network. Typically, their capacity requirements are of the order of a few million calls per hour because they have only transitioned a small part of their network to SIP. However, longer term plans can result in a requirement of tens of millions of calls per hour. Therefore, service providers need SIP platforms with a scalable architecture that are initially deployed with a lower capacity capability but can have increased capacity over time by adding servers in a cost effective manner.

The SSR provides a scalable architecture that can be configured for low traffic and high traffic applications. Some key technologies that provide that capability are described in the following subsections.

### Hardware Architecture:

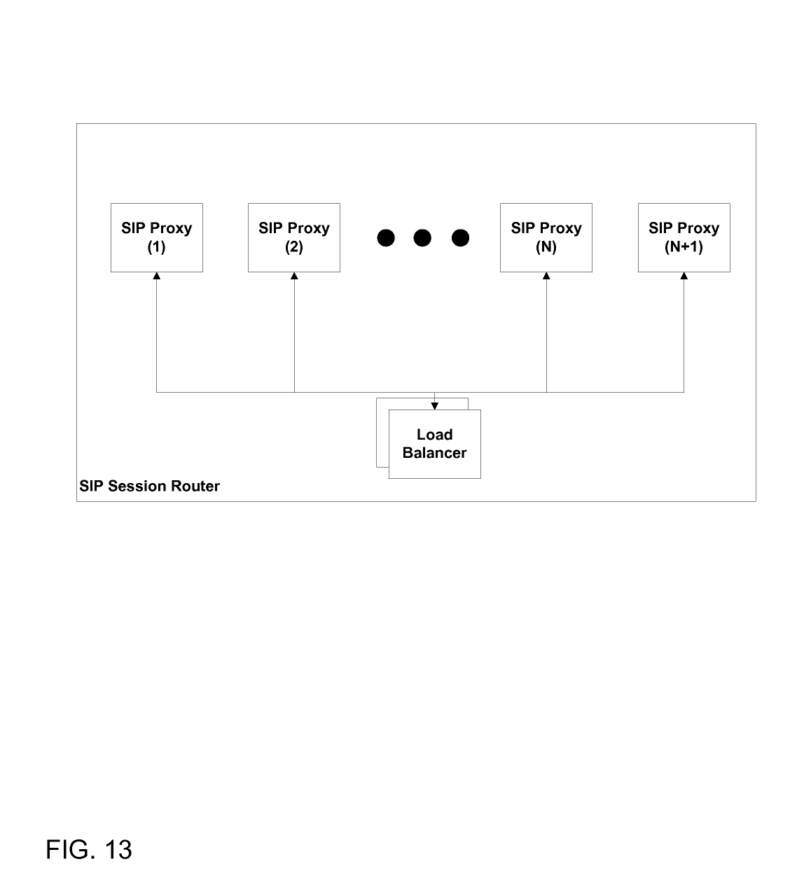

The SSR hardware architecture according to embodiments is depicted in FIG. 13. The system consists of multiple interconnected servers. The Load Balancer function is deployed on a pair of redundant servers and the SIP Proxy function is deployed on N+1 servers. Each SIP Proxy server is capable of processing X messages per second. When a SIP

Proxy server is added to the system configuration, the overall system capacity is increased by X messages per second.

### Software Architecture:

SIP traffic from the service provider's network routing through the SSR arrives at the server pair that contains the Load Balancer function. The Load Balancer is an optimized message router that forwards the initial request message of a new SIP call to one of the N+1 SIP Proxy servers. The Load Balancer also remembers which SIP Proxy handled that message so that it can route subsequent messages of the same SIP call to the same SIP Proxy server.

The Load Balancer distributes new SIP calls to the least busy SIP Proxy server. The Load Balancer knows the nearly instantaneous processing load of each SIP Proxy because they periodically send an indication of their current processing load to the Load Balancer. The Load Balancer selects the SIP Proxy server to offer a new SIP call to based on the SIP Proxy that indicates it is the least busy of the N+1 pool of SIP Proxy servers. This algorithm effectively provides an overload control mechanism so that individual SIP Proxies are not offered more traffic than they can handle.

Since the Load Balancer is deployed on a redundant pair of servers, it can utilize traditional software-based primary and backup redundancy techniques. A primary Load Balancer software process runs on one server and a backup Load Balancer software process runs on another server. When the primary Load Balancer receives a new call, it synchronizes that information to the backup Load Balancer on the other server. If the primary Load Balancer fails, the backup Load Balancer becomes the primary and can then finish calls in progress.

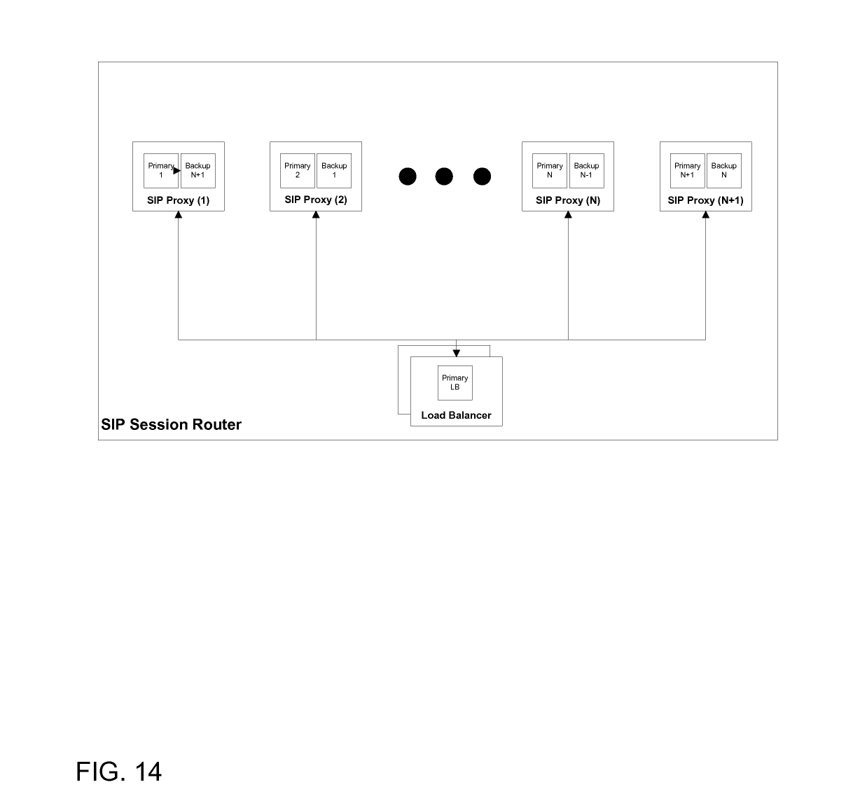

The SIP Proxies also use a traditional software based primary and backup redundancy technique, except that the SIP proxies are deployed on N+1 servers instead of a pair of servers. On a typical configuration, a primary SIP Proxy software process is deployed on server 1 and its backup SIP Proxy software process is deployed on server 2. Server 2 also has a primary SIP proxy process and its backup SIP Proxy process is deployed on server 3. This process configuration methodology continues for each SIP Proxy through the Nth server and the N+1 server. The backup SIP Proxy process for the N+1 server is deployed on server 1. Thus, each SIP Proxy has a primary and backup process allowing the SSR to preserve stable calls in the presence of a SIP Proxy failure. The software architecture of the SSR according to embodiments is depicted in FIG. 14.

The typical deployment model of early NGN has been to couple a feature server with media gateway control in what is effectively the softswitch entity. Typically, there is a one-to-one relationship between the switching and feature server components. However, evolution is taking NGN towards the IMS model where there are a number of application servers in the network that provide the subscriber experience. In addition, larger networks inherently require larger call capacity and resiliency, not well served by this one-to-one architecture. What is needed is the ability to expand the deployment to include a larger number of application servers, while at the same time ensuring that those resources are load balanced and collectively present a resilient resource.

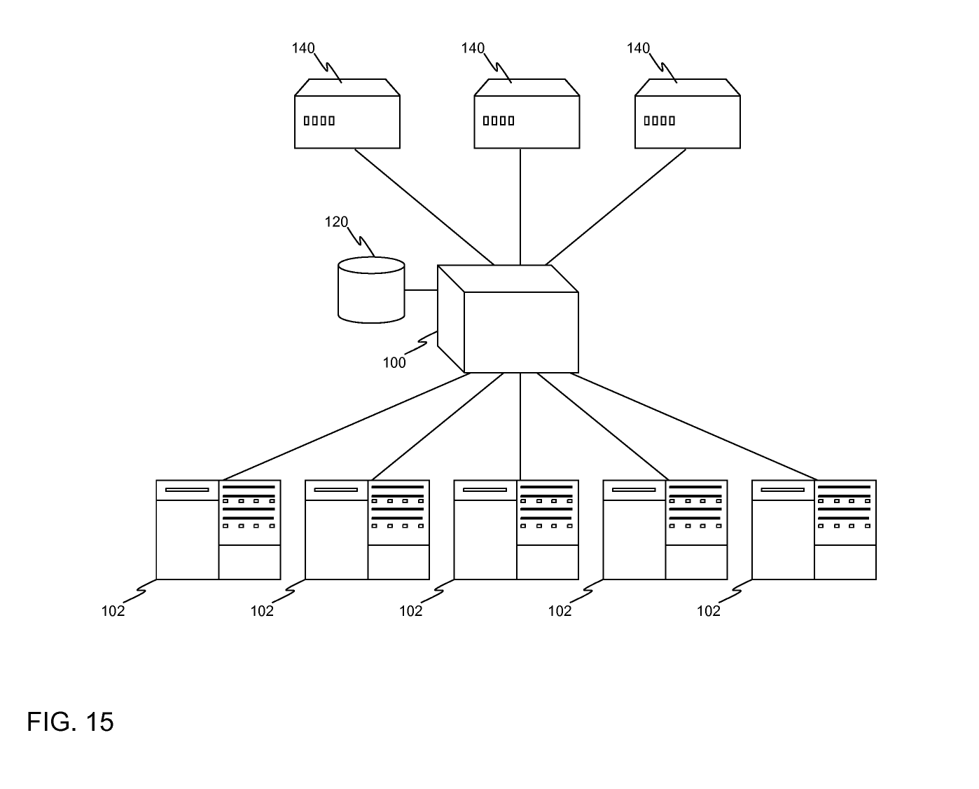

The SSR provides the ability to proxy application/feature servers towards the switching infrastructure by appearing as a single application server entity towards any number of switches. The switches in turn are provisioned to forward SIP signalling towards a single SSR entity that has the shared capacity of all application servers. The SSR provides the capability for identifying and correctly forwarding traffic towards the correct application server and provides a mechanism to load balance and diminish the impact of application server failures when multiple servers are pooled. Depending on the service provider needs, the growth of application servers and switches can now happen asynchronously, adding capacity only where it is needed. Furthermore, overall network uptime and service availability is greatly enhanced as server failures can be non-service affecting. Such deployment of an SSR 100 (with routing database 120) providing load balancing functionality in relation to a number of softswitches 102 and application servers 140 is depicted in FIG. 15.

Logically, the application server load balancing functionality within the SSR is similar to the media server brokering functionality depicted in FIG. 11.

### Network Topology

### Mated Pairs:

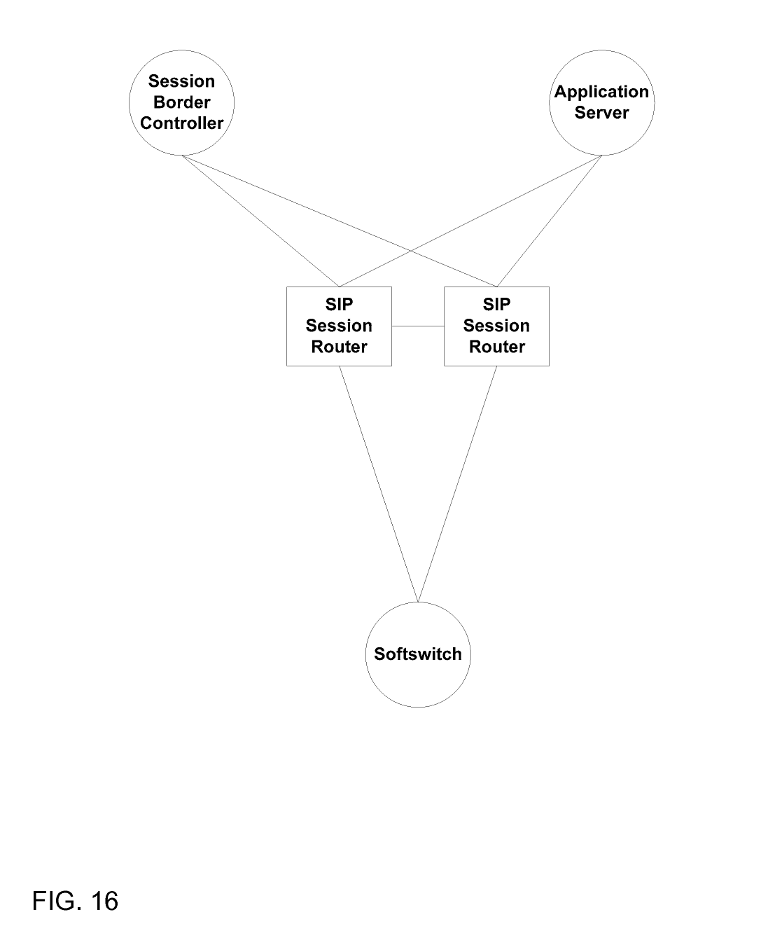

In embodiments, the SSR is a fully redundant carrier class network element with 99.999% availability. However, catastrophic outages such as a fire or flood at a central office can take out a single SSR and cause a total traffic outage. To avoid this outage, in embodiments, service providers deploy SSRs in mated pairs in the network with diverse geographical locations. Connected nodes can offer traffic to either SSR of the mated pair. If one SSR is out of service, then the connected node can route the traffic to the SSR mate. This architecture is depicted in FIG. 16.

In embodiments, the network comprises two SSRs operating as a mated pair where the two SSRs are located remotely from each other. The routing database of one SSR in the mated pair is synchronised with the routing database of the other SSR in the mated pair.

### Database Synchronization:

Since the SSR maintains an internal routing database it is important that both SSRs of a mated pair contain identical routing databases. The SSR provides a mechanism to synchronize the routing database between the mated pair of SSRs as follows:
a) As a routing database change is made on one SSR, the change is synchronized with the mated SSR before the change is acknowledged to the operator.
b) The SSR also provides a continuously running database audit that compares the database in one SSR to the same database in the mated SSR. If discrepancies are discovered, the operator is notified so that they can take recovery actions.

To overcome the issues service providers face in deployment of next generation SIP signalling networks, the SSR describes a unique combination of essential network based functionalities that allow service providers to solve numerous signalling and networking issues. The SSR therefore comprises some or all of the following features in any combination:

a) Proxy server stateless, transaction stateful, and call stateful operation
b) Back-to-Back User Agent (B2BUA) operation
c) SIP protocol message normalization
d) SIP signalling network management
e) SIP Service Node architecture
f) Enhanced routing
g) Scalable for high capacity applications
h) Mated pair operation for maximum reliability

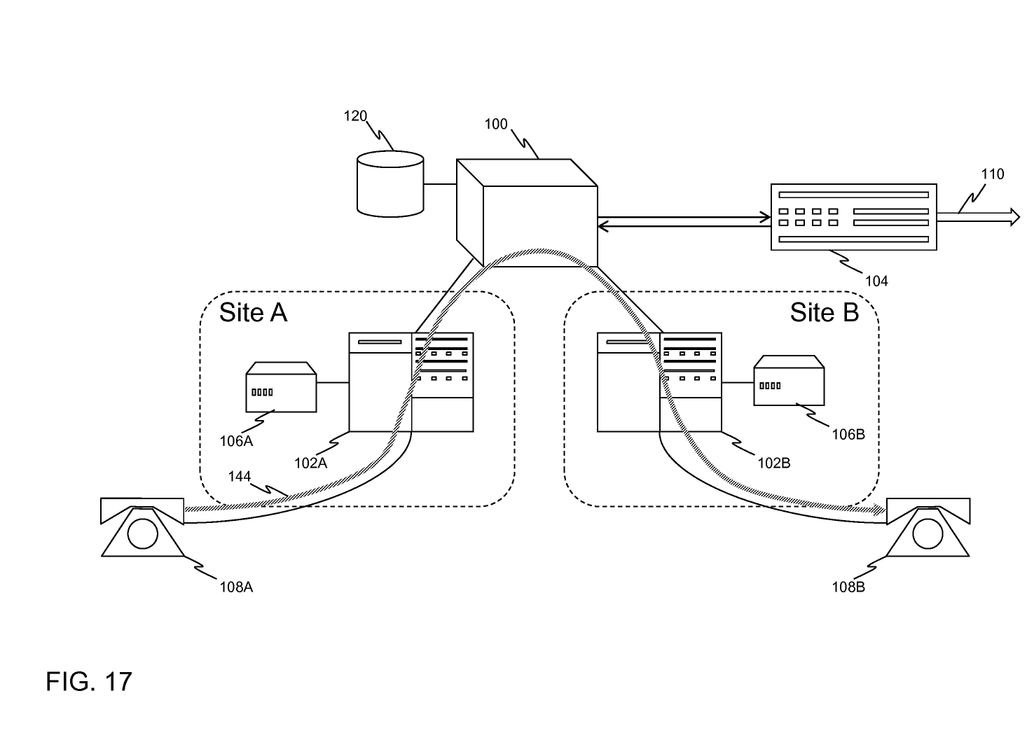

Embodiments relate to enterprise trunking where for example it is assumed that a customer has several large campuses across a country and desires to have each IP PBX communicate with each other. In prior art systems, the service provider may currently simply send each IP PBX back towards the PSTN via session border gateways, meaning that calls between two IP PBXs effectively ‘trombone’ via the PSTN consuming valuable circuits and time-division multiplexing (TDM) switching equipment. However, by utilizing the SSR, the service provider may configure SIP routes that keep the traffic “OnNet” of the SIP enterprise customer as illustrated in FIG. 17. The “OnNet” traffic path (i.e. media path) is shown by item 144 in FIG. 17. Employing an SSR according to embodiments reduces latency, lowers operational and equipment costs and delivers better service quality.

NGN networks are growing, with current subscribers moving from circuit-switched TDM networks. Current applications and services need to be provided to those migrated customers, which often means reutilizing existing IN SCPs and servers. Services such as Calling Name (CNAM), Local number portability (LNP), 800/Freephone, etc. are usually hosted by IN-based servers that have enough capacity to support PSTN and NGN subscribers and are therefore not targets for transition to SIP.

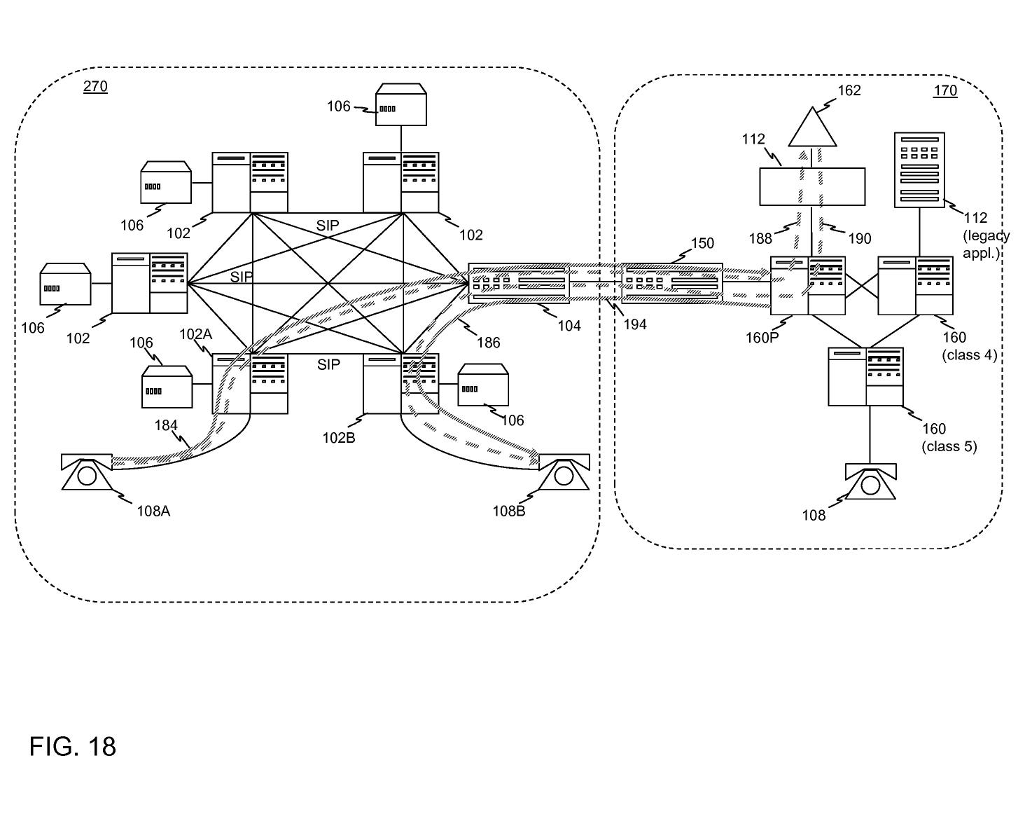

A prior art implementation involves simply forwarding calls that require such services back towards the PSTN to be serviced, as depicted in FIG. 18. This prior art example includes an NGN network 270 and a PSTN 170. User A (having user device 108A in NGN 270) tries to reach User B (having user device 108B in NGN 270), who is subscribed to a voice VPN service. As the local softswitch 102A does not know how to reach that user, the call is forwarded out from NGN 270 towards PSTN 170 and terminated at a Class 4 switch 160P which triggers an SCP 162 for the number (VPN) lookup via Intelligent Network Application Part (INAP) or Transaction Capabilities Application Part (TCAP). The entire call is forwarded, which means that signalling as well as bearer (media data traffic) is delivered from NGN 270 to PSTN 170 via signalling path 188 and bearer path 184 and anchored on Class 4 switch 160P. Class 4 switch 160P in turn sends the call, including signalling path 190 and bearer path 194, back out of PSTN 170 towards the appropriate softswitch 102B in NGN 270, thereby consuming two bearer (e.g. voice) circuits for the duration of the call. By the time the call ends, it would have consumed two resources on the session border gateway 104, media gateway 150 and Class 4 switch.

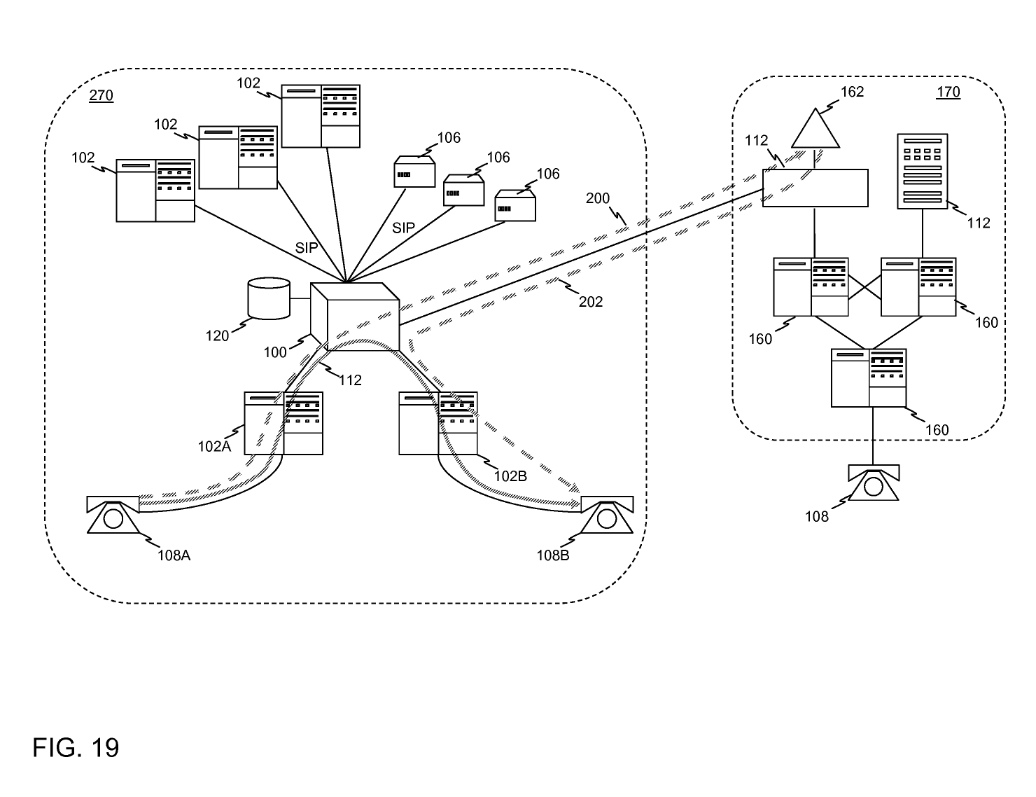

Embodiments involve SSR 100 incorporating service broker functionality and provide an improved way of delivering such legacy services on the NGN by intelligently performing only the Intelligent Network transaction, without the need for bearer tromboning to/from the PSTN. This requires that some element on the NGN identifies this need and makes the IN lookup on the behalf of the softswitch, in this case SSR 100 as shown in FIG. 19.

In FIG. 19, SSR 100 is deployed in NGN 270 to provide SIP routing between softswitches 102, and hence is a transversal point for SIP traffic outside the local softswitch. By providing IN support on SSR 100, the SSR is able to perform this address lookup natively during call setup. As User A makes the outbound call to User B, SSR 100 performs the IN lookup after the initial SIP INVITE from User A, but before any Session Description Protocol (SDP) has been negotiated and without having to send the call towards PSTN 170.

The SSR may be configured to support either SS7 links or SIGTRAN associations natively and as such only needs to send signalling towards the PSTN, which means that valuable bearer circuits are not tied and tromboned across the PSTN network. The signalling path for the call can therefore be seen to pass from user device 108A to SCP 162 in PSTN 170 denoted by item 200 and then from SCP 162 to user device 108B denoted by item 202. In contrast, the bearer (media data) path denoted by item 112 for the call can be seen to pass from user device 108A to user device 108B via softswitches 102A, 102B and SSR 100, but not via PSTN 170.

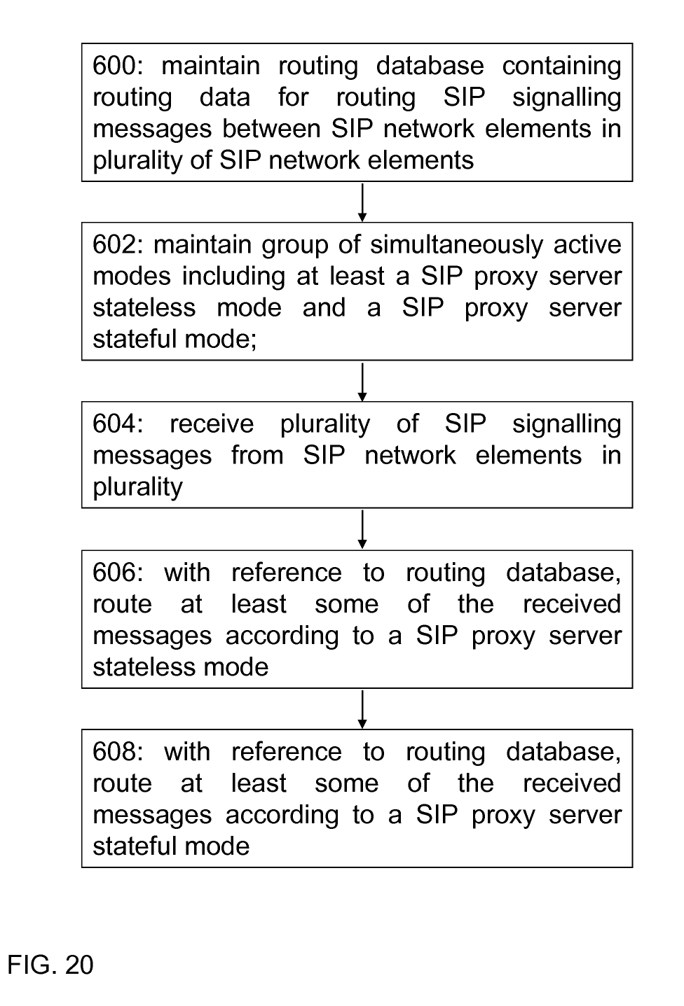

FIG. 20 shows a flow diagram according to embodiments. Such embodiments relate to processing SIP signalling messages in a telecommunications network. The network comprises a SIP routing element and a plurality of SIP network elements, each of the SIP network elements in the plurality being configured to forward SIP signalling messages to the SIP routing element for routing across the network. Item 600 involves the SIP routing element maintaining a routing database containing routing data for routing SIP signalling messages between SIP network elements in the plurality. Item 602 involves the SIP routing element maintaining a group of simultaneously active modes including at least a SIP proxy server stateless mode and a SIP proxy server stateful mode. Item 604 involves the SIP routing element receiving a plurality of SIP signalling messages from SIP network elements in the plurality of SIP network elements. Item 606 involves the SIP routing element routing at least some of the received SIP signalling messages with reference to the routing database according to a SIP proxy server stateless mode. Item 608 involves the SIP routing element routing at least some of the received messages with reference to the routing database according to a SIP proxy server stateful mode.

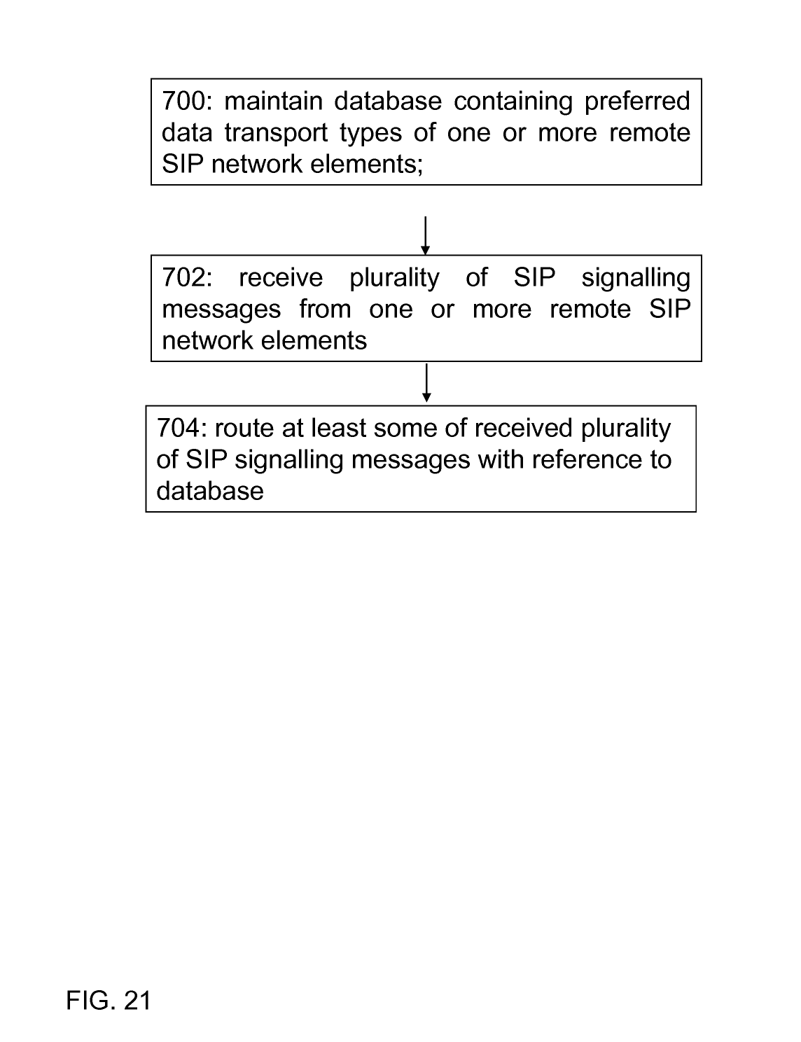

FIG. 21 shows a flow diagram according to embodiments. Such embodiments relate to processing SIP signalling messages in a telecommunications network comprising a plurality of SIP network elements. Item 700 involves a SIP network element maintaining a database containing preferred data transport types of one or more remote SIP network elements. Item 702 involves the SIP network element receiving a plurality of SIP signalling messages from one or more remote SIP network elements. Item 704 involves the SIP network element routing at least some of the received plurality of SIP signalling messages with reference to the database.

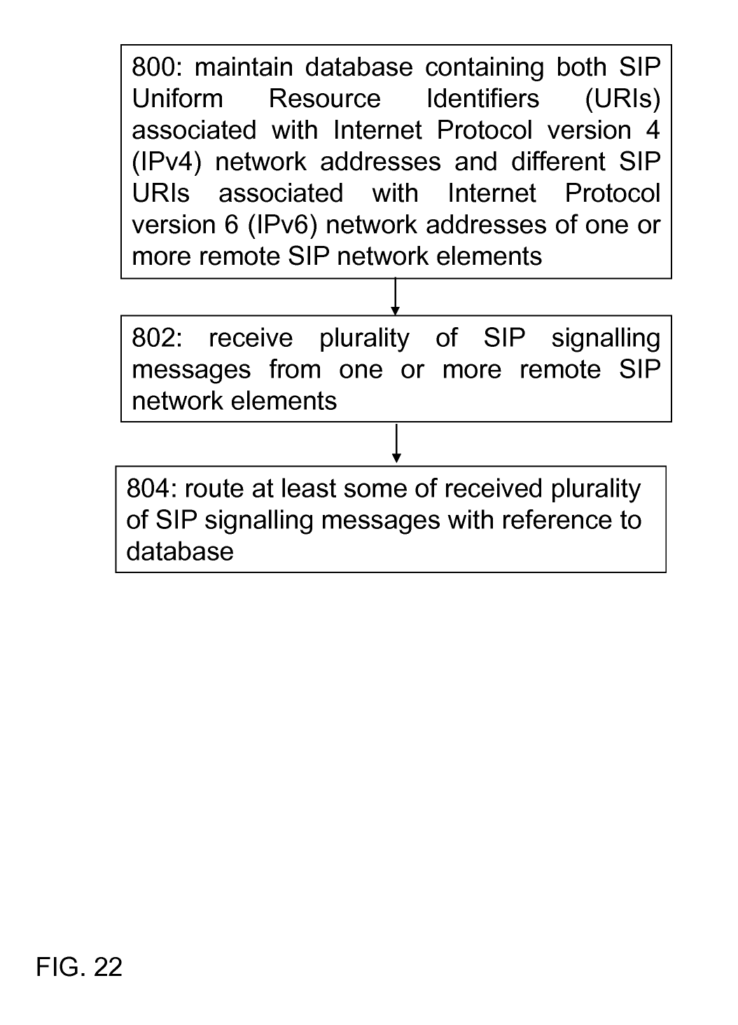

FIG. 22 shows a flow diagram according to embodiments. Such embodiments relate to processing SIP signalling messages in a telecommunications network comprising a plurality of SIP network elements. Item 800 involves a SIP network element maintaining a database containing both SIP Uniform Resource Identifiers (URIs) associated with Internet Protocol version 4 (IPv4) network addresses and different SIP URIs associated with Internet Protocol version 6 (IPv6) network addresses of one or more remote SIP network elements. Item 802 involves the SIP network element receiving a plurality of SIP signalling messages from one or more remote SIP network elements. Item 804 involves the SIP network element routing at least some of the received plurality of SIP signalling messages with reference to the database.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. In embodiments, the SSR includes any combination of none, some or all of the features in the dependent claims laid out below. Furthermore, equivalents and modifications not described above may also be employed without departing from the scope of the invention, which is defined in the accompanying claims.

What is claimed is:

1. A method of processing Session Initiation Protocol (SIP) signalling messages in a telecommunications network, the network comprising a SIP routing element and a plurality of SIP network elements, each of the SIP network elements in the plurality being configured to forward SIP signalling messages to the SIP routing element for routing across the network, the method comprising, at the SIP routing element:
maintaining a routing database containing routing data for routing SIP signalling messages between SIP network elements in the plurality;
maintaining a group of simultaneously active modes including at least a SIP proxy server stateless mode and a SIP proxy server stateful mode;
receiving a plurality of SIP signalling messages from SIP network elements in the plurality of SIP network elements;
routing at least some of the received SIP signalling messages with reference to the routing database according to a SIP proxy server stateless mode; and
routing at least some of the received messages with reference to the routing database according to a SIP proxy server stateful mode.

2. The method according to claim 1, further comprising:
maintaining a group of simultaneously active modes including at least a SIP proxy server stateless mode, a SIP proxy server transaction stateful mode and a SIP proxy server call stateful mode;
routing at least some of the received SIP signalling messages with reference to the routing database according to a SIP proxy server stateless mode;
routing at least some of the received SIP signalling messages with reference to the routing database according to a SIP proxy server transaction stateful mode; and
routing at least some of the received SIP signalling messages with reference to the routing database according to a SIP proxy server call stateful mode.

3. The method according to claim 1, further comprising processing at least some of the received messages according to a SIP back-to-back user agent mode.

4. The method according to claim 1, further comprising provision of service broker functionality in relation to at least some of the received messages.

5. The method according to claim 1, further comprising providing media resource broker functionality in relation to at least some of the received messages.

6. The method according to claim 1, further comprising providing session centralisation and continuity application server functionality in relation to at least some of the received messages.

7. The method according to claim 1, further comprising providing load balancing functionality in relation to one or more application server SIP network elements and/or one or more media server SIP network elements.

8. The method according to claim 1, wherein the network comprises a further SIP routing element operating as a mated pair in relation to the SIP routing element, the two SIP routing elements being located remotely from each other, the method comprising synchronising the routing database of one SIP routing element in the mated pair with the routing database of the other SIP routing element in the mated pair.

9. The method according to claim 1, further comprising routing at least some of the received messages with reference to an external routing database.

10. The method according to claim 1, further comprising carrying out SIP protocol message normalisation in relation to at least some of the received messages.

11. The method according to claim 1, further comprising discarding one or more of said received messages during message overload conditions.

12. The method according to claim 1, further comprising generating, at least on the basis of said received messages, one or more SIP signalling message traffic metrics and/or one or more event based session detail records.

13. The method according to claim 1, further comprising monitoring the availability of one or more SIP network elements in the plurality.

14. The method according to claim 1, further comprising providing service assurance functionality.

15. The method according to claim 1, further comprising providing route advance functionality in relation to the routing of at least some of the received messages according to a SIP proxy server transaction stateful mode and/or the routing of at least some of the received messages according to a SIP proxy server call stateful mode.

16. The method according to claim 1, further comprising routing at least some of the received messages on the basis of one or more of the following data contained in the respective received message:
a telephone dialing number,
a SIP Uniform Resource Identifiers (URI) or other SIP header, and
a portion of a SIP URI or other SIP header.

17. Apparatus for use in processing Session Initiation Protocol (SIP) signalling messages in a telecommunications network, the network comprising a SIP routing element and a plurality of SIP network elements, each of the SIP network elements in the plurality being configured to forward SIP signalling messages to the SIP routing element for routing across the network, the apparatus being adapted to, at the SIP routing element:
maintain a routing database containing routing data for routing SIP signalling messages between SIP network elements in the plurality;
maintain a group of simultaneously active modes including at least a SIP proxy server stateless mode and a SIP proxy server stateful mode; receive a plurality of SIP signalling messages from SIP network elements in the plurality of SIP network elements;
route at least some of the received SIP signalling messages with reference to the routing database according to a SIP proxy server stateless mode; and
route at least some of the received messages with reference to the routing database according to a SIP proxy server stateful mode.

18. A computer program product comprising a non-transitory computer-readable storage medium having computer readable instructions stored thereon, the computer readable instructions being executable by a computerized device to cause the computerized device to perform a method for processing Session Initiation Protocol (SIP) signalling messages in a telecommunications network, the network comprising a SIP routing element and a plurality of SIP network elements, each of the SIP network elements in the plurality being configured to forward SIP signalling messages to the SIP routing element for routing across the network, the method comprising, at the SIP routing element:
maintain a routing database containing routing data for routing SIP signalling messages between SIP network elements in the plurality;
maintain a group of simultaneously active modes including at least a SIP proxy server stateless mode and a SIP proxy server stateful mode;
receive a plurality of SIP signalling messages from SIP network elements in the plurality of SIP network elements;
route at least some of the received SIP signalling messages with reference to the routing database according to a SIP proxy server stateless mode; and
route at least some of the received messages with reference to the routing database according to a SIP proxy server stateful mode.

19. A method of processing Session Initiation Protocol (SIP) signalling messages in a telecommunications network comprising a plurality of SIP network elements, the method comprising, at a SIP network element:
maintaining a database containing preferred data transport types of one or more remote SIP network elements;
receiving a plurality of SIP signalling messages from one or more remote SIP network elements; and
routing at least some of the received plurality of SIP signalling messages with reference to the database.

20. A method of processing Session Initiation Protocol (SIP) signalling messages in a telecommunications network comprising a plurality of SIP network elements, the method comprising, at a SIP network element:
maintaining a database containing both SIP Uniform Resource Identifiers (URIs) associated with Internet Protocol version 4 (IPv4) network addresses and different SIP URIs associated with Internet Protocol version 6 (IPv6) network addresses of one or more remote SIP network elements;
receiving a plurality of SIP signalling messages from one or more remote SIP network elements;
routing at least some of the received plurality of SIP signalling messages with reference to the database.
